(19) United States
(12) Patent Application Publication
(10) Pub. No.: US 2021/0065002 A1
(43) Pub. Date: Mar. 4, 2021

(54) CONCEPTS FOR DISTRIBUTED LEARNING OF NEURAL NETWORKS AND/OR TRANSMISSION OF PARAMETERIZATION UPDATES THEREFOR

(71) Applicant: Fraunhofer-Gesellschaft zur Förderung der angewandten Forschung e.V., Munich (DE)

(72) Inventors: Wojciech SAMEK, Berlin (DE); Simon WIEDEMANN, Berlin (DE); Felix SATTLER, Berlin (DE); Klaus-Robert MÜLLER, Berlin (DE); Thomas WIEGAND, Berlin (DE)

(21) Appl. No.: 17/096,887

(22) Filed: Nov. 12, 2020

Related U.S. Application Data
(63) Continuation of application No. PCT/EP2019/062683, filed on May 16, 2019.

(30) Foreign Application Priority Data
May 17, 2018 (EP) 18173020.1

(51) Int. Cl. G06N 3/08; G06N 3/04; G06K 9/62

(52) U.S. Cl. CPC G06N 3/08; G06K 9/6256; G06N 3/04

(57) ABSTRACT

The present application is concerned with several aspects of improving the efficiency of distributed learning.

### CROSS-REFERENCE TO RELATED APPLICATIONS

This application is a continuation of copending International Application No. PCT/EP2019/062683, filed May 16, 2019, which is incorporated herein by reference in its entirety, and additionally claims priority from European Application No. EP18173020.1, filed May 17, 2018, which is also incorporated herein by reference in its entirety.

### BACKGROUND

The present application is concerned with distributed learning of neural networks such as federated learning or data-parallel learning, and concepts which may be used therein such as concepts for transmission of parameterization updates.

In most common machine learning scenarios it is assumed, or even needed, that all the data from which the algorithm is trained on is gathered and localized in a central node. However, in many real world applications, the data is distributed among several nodes, e.g., in IoT or mobile applications, implying that it can only be accessed through these nodes. That is, it is assumed that the data cannot be collected in a single central node. This might be, for instance, because of efficiency reasons and/or privacy reasons. Consequently, the training of machine learning algorithms is modified and accommodated to this distributed scenario.

The field of distributed deep learning is concerned with the problem of training neural networks in such a distributed learning setting. In principle, the training is usually divided into two stages. One, the neural network is trained at each node on the local data and, two, a communication round where the nodes share their training progress with each other. The process may be cyclically repeated. The last step is essential because it merges the learnings made at each node into the neural network, eventually allowing it to generalize throughout the entire distributed data set.

It becomes immediately clear that distributed learning, while spreading the computational load onto several entities, comes at the cost of having to communicate data to and from the individual nodes or clients. Thus, in order to achieve an efficient learning scenario, the communication overhead needs to be kept at a reasonable amount. If lossy coding is used for the communication, care should be taken as coding loss may slow down the learning progress and, accordingly, increase the cycles entailed in order to attain a converged state of the neural network's parameterization.

Accordingly, it is an object of the present invention to provide concepts for distributed learning which render distributed learning more efficient.

### SUMMARY

According to an embodiment, a method for federated learning of a neural network by clients in cycles may have the steps of, in each cycle: downloading, to a predetermined client, information on a setting of a parameterization of the neural network, the predetermined client, updating the setting of the parameterization of the neural network using training data at least partially individually gathered by the respective client to obtain a parameterization update, and uploading information on the parameterization update, merging the parameterization update with further parametrization updates of other clients to obtain a merged parameterization update defining a further setting for the parameterization for a subsequent cycle, wherein the uploading of the information on the parameterization update has lossy coding of an accumulated parametrization update corresponding to a first accumulation of the parameterization update of a current cycle on the one hand and coding losses of uploads of information on parameterization updates of previous cycles on the other hand.

Another embodiment may have a system for federated learning of a neural network in cycles, the system having a server and clients and configured to, in each cycle download, from the server to a predetermined client, information on a setting of a parameterization of the neural network, the predetermined client, updating the setting of the parameterization of the neural network using training data at least partially individually gathered by the respective client to obtain a parameterization update, and uploading information on the parameterization update, merge, by the server, the parameterization update with further parametrization updates of other clients to obtain a merged parameterization update defining a further setting for the parameterization for a subsequent cycle, wherein the uploading of the information on the parameterization update has lossy coding of an accumulated parametrization update corresponding to a first accumulation of the parameterization update of a current cycle on the one hand and coding losses of uploads of information on parameterization updates of previous cycles on the other hand.

Another embodiment may have a client device for decentralized training contribution to federated learning of a neural network in cycles, the client device being configured to, in each cycle, receive information on a setting of a parameterization of the neural network, gather training data, update the setting of the parameterization of the neural network using the training data to obtain a parameterization update, and uploading information on the parameterization update for being merged with the parameterization updates of other clients deices to obtain a merged parameterization update defining a further setting of the parameterization for a subsequent cycle, wherein the client device is configured to, in uploading the information on the parameterization update, lossy code an accumulated parametrization update corresponding to a first accumulation of the parameterization update of a current cycle on the one hand and coding losses of uploads of information on parameterization updates of previous cycles on the other hand.

According to another embodiment, a method for decentralized training contribution to federated learning of a neural network in cycles may have the steps of, in each cycle: receiving information on a setting of a parameterization of the neural network, gathering training data, updating the setting of the parameterization of the neural network using the training data to obtain a parameterization update, and uploading information on the parameterization update for being merged with the parameterization updates of other clients deices to obtain a merged parameterization update defining a further setting of the parameterization for a subsequent cycle, wherein the method has, in uploading the information on the parameterization update, lossy coding an accumulated parametrization update corresponding to a first accumulation of the parameterization update of a current cycle on the one hand and coding losses of uploads of information on parameterization updates of previous cycles on the other hand.

According to still another embodiment, a method for distributed learning of a neural network by clients in cycles may have the steps of, in each cycle: downloading, to a predetermined client, information on a setting of a parameterization of the neural network, the predetermined client updating the setting of the parameterization of the neural network using training data to obtain a parameterization update, and uploading information on the parameterization update, merging the parameterization update with further parametrization updates of the other clients to obtain a merged parameterization update which defines a further setting of the parameterization for a subsequent cycle, wherein, in a predetermined cycle, the downloading the information on the setting of the parameterization of the neural network has downloading information on the merged parametrization update of a preceding cycle by lossy coding of an accumulated merged parametrization update corresponding to a first accumulation of the merged parametrization update of the preceding cycle on the one hand and coding losses of downloads of information on merged parametrization updates of cycles preceding the preceding cycle on the other hand.

Another embodiment may have a system for distributed learning of a neural network in cycles, the system having a server and clients and configured to, in each cycle download, from the server to a predetermined client, information on a setting of a parameterization of the neural network, the predetermined client updating the setting of the parameterization of the neural network using training data to obtain a parameterization update, and uploading information on the parameterization update, merge, by the server, the parameterization update with further parametrization updates of the other clients to obtain a merged parameterization update which defines a further setting of the parameterization for a subsequent cycle, wherein, in a predetermined cycle, the downloading the information on the setting of the parameterization of the neural network has downloading information on the merged parametrization update of a preceding cycle by lossy coding of an accumulated merged parametrization update corresponding to a first accumulation of the merged parametrization update of the preceding cycle on the one hand and coding losses of downloads of information on merged parametrization updates of cycles preceding the preceding cycle on the other hand.

Another embodiment may have an apparatus for coordinating a distributed learning of a neural network by clients in cycles, the apparatus configured to, per cycle, download, to a predetermined client, information on a setting of a parameterization of the neural network for sake of the clients updating the setting of the parameterization of the neural network using training data to obtain a parameterization update, receive information on the parameterization update from the predetermined client, merge the parameterization update with further parametrization updates from other clients to obtain a merged parameterization update which defines a further setting of the parameterization for a subsequent cycle, wherein the apparatus is configured to, in a predetermined cycle, in downloading the information on the setting of the parameterization of the neural network, download the merged parametrization update of a preceding cycle by lossy coding of an accumulated merged parametrization update corresponding to a first accumulation of the merged parametrization update of the preceding cycle on the one hand and coding losses of downloads of information on merged parametrization updates of cycles preceding the preceding cycle on the other hand.

According to another embodiment, a method for coordinating a distributed learning of a neural network by clients in cycles may have the step of, per cycle, downloading, to a predetermined client, information on a setting of a parameterization of the neural network for sake of the clients updating the setting of the parameterization of the neural network using training data to obtain a parameterization update, receiving information on the parameterization update from the predetermined client, merging the parameterization update with further parametrization updates from other clients to obtain a merged parameterization update which defines a further setting of the parameterization for a subsequent cycle, wherein the method has, in a predetermined cycle, in downloading the information on the setting of the parameterization of the neural network, downloading the merged parametrization update of a preceding cycle by lossy coding of an accumulated merged parametrization update corresponding to a first accumulation of the merged parametrization update of the preceding cycle on the one hand and coding losses of downloads of information on merged parametrization updates of cycles preceding the preceding cycle on the other hand.

Still another embodiment may have a non-transitory digital storage medium having stored thereon a computer program for performing a method of for federated learning of a neural network by clients in cycles, the method having in each cycle downloading, to a predetermined client, information on a setting of a parameterization of the neural network, the predetermined client, updating the setting of the parameterization of the neural network using training data at least partially individually gathered by the respective client to obtain a parameterization update, and uploading information on the parameterization update, merging the parameterization update with further parametrization updates of other clients to obtain a merged parameterization update defining a further setting for the parameterization for a subsequent cycle, wherein the uploading of the information on the parameterization update has lossy coding of an accumulated parametrization update corresponding to a first accumulation of the parameterization update of a current cycle on the one hand and coding losses of uploads of information on parameterization updates of previous cycles on the other hand, when said computer program is run by a computer.

Another embodiment may have a non-transitory digital storage medium having stored thereon a computer program for performing a method for coordinating a distributed learning of a neural network by clients in cycles, the method having, per cycle, downloading, to a predetermined client, information on a setting of a parameterization of the neural network for sake of the clients updating the setting of the parameterization of the neural network using training data to obtain a parameterization update, receiving information on the parameterization update from the predetermined client, merging the parameterization update with further parametrization updates from other clients to obtain a merged parameterization update which defines a further setting of the parameterization for a subsequent cycle, wherein the method has, in a predetermined cycle, in downloading the information on the setting of the parameterization of the neural network, downloading the merged parametrization update of a preceding cycle by lossy coding of an accumulated merged parametrization update corresponding to a first accumulation of the merged parametrization update of the preceding cycle on the one hand and coding losses of downloads of information on merged parametrization updates of cycles preceding the preceding cycle on the other hand, when said computer program is run by a computer.

The present application is concerned with several aspects of improving the efficiency of distributed learning. In accordance with a first aspect, for example, a special type of distributed learning scenario, namely federated learning, is improved by performing the upload of parameterization updates obtained by the individual nodes or clients using at least partially individually gathered training data by use of lossy coding. In particular, an accumulated parameterization update corresponding to an accumulation of the parameterization update of a current cycle on the one hand and coding losses of uploads of information on parameterization updates of previous cycles on the other hand is performed. The inventors of the present application found out that the accumulation of the coding losses of the parameterization update uploads in order to be accumulated onto current parameterization updates increases the coding efficiency even in cases of federated learning where the training data is—at least partially—gathered individually by the respective clients or nodes, i.e., circumstances where the amount of training data and the sort of training data is non-evenly distributed over the various clients/nodes and where the individual clients typically perform their training in parallel without merging their training results more intensively. The accumulation offers, for instance, an increase of the coding loss at equal learning convergence rate or vice versa offers increased learning convergence rate at equal communication overhead for the parameterization updates.

In accordance with a further aspect of the present application, distributed learning scenarios, irrespective of being of the federated or data-parallel learning type, are made more efficient by performing the download of information on parameterization settings to the individual clients/nodes by downloading merged parameterization updates resulting from merging the parameterization updates of the clients in each cycle and, additionally, performing this download of merged parameterization updates using lossy coding of an accumulated merge parameterization update. That is, in order to inform clients on the parameterization setting in a current cycle, a merged parameterization update of a preceding cycle is downloaded. To this end, an accumulated merged parameterization update corresponding to an accumulation of the merged parameterization update of a preceding cycle on the one hand and coding losses of downloads of merged parameterization updates of cycles preceding the preceding cycle on the other hand is lossy coded. The inventors of the present invention have found that even the downlink path for providing the individual clients/nodes with the starting point for the individual trainings forms a possible occasion for improving the learning efficiency in a distributed learning environment. By rendering the merged parameterization update download aware of coding losses of previous downloads, the download data amount may, for instance, be reduced at the same or almost the same learning convergence rate or vice versa, the learning convergence rate may be increased at using the same download overhead.

Another aspect which the present application relates to is concerned with parameterization update coding in general, i.e., irrespective of being used relating to downloads of merged parameterization updates or uploads of individual parameterization updates, and irrespective of being used in distributed learning scenarios of the federated or data-parallel learning type. In accordance with this aspect, consecutive parameterization updates are lossy coded and entropy coding is used. The probability disruption estimates used for entropy coding for a current parameterization update are derived from an evaluation of the lossy coding of previous parameterization updates or, in other words, depending on an evaluation of portions of the neural network's parameterization for which no update values are coded in previous parameterization updates. The inventors of the present invention have found that evaluating, for instance, for each parameter of the neural network's parameterization whether, and for which cycle, an update value has been coded in the previous parameterization updates, i.e., the parameterization updates in the previous cycles, enables to gain knowledge about the probability distribution for lossy coding the current parameterization update. Owing to the improved probability distribution estimates, the coding efficiency in entropy coding the lossy coded consecutive parameterization updates is rendered more efficient. The concept works with or without coding loss aggregation. For example, based on the evaluation of the lossy coding of previous parameterization updates, it might be determined for each parameter of the parameterization, whether an update value is coded in a current parameterization update or not, i.e., is left uncoded. A flag may then be coded for each parameter to indicate whether for the respective parameter an update value is coded by the lossy coding by the current parameterization update, or not, and the flag may be coded using entropy coding using the determined probability of the respective parameter. Alternatively, the parameters for which update values are comprised by the lossy coding of the current parameterization update may be indicated by pointers or addresses coded using a variable length code, the code word length of which increases for the parameters in an order which depends on, or increases with, the probability for the respective parameter to have an update value included by the lossy coding of the current parameterization update.

An even further aspect of the present application relates to the coding of parameterization updates irrespective of being used in download or upload direction, and irrespective of being used in a federated or data-parallel learning scenario, wherein the coding of consecutive parameterization updates is done using lossy coding, namely by coding identification information which identifies the coded set of parameters for which the update values belong to the coded set of update values along with an average value for representing the coded set of update values, i.e. they are quantized to that average value. The scheme is very efficient in terms of weighing up between data amount spent per parametrization update on the one hand and convergence speed on the other had. In accordance with an embodiment, the efficiency, i.e. the weighing up between data amount on the one hand and convergence speed on the other hand, is increased even further by determining the set of coded parameters for which an update value is comprised by the lossy coding of the parameterization update in the following manner: two sets of updated values in the current parameterization update are determined, namely a first set of highest update values and a second set of lowest update values. Among same, the largest set is selected as the coded set of update values, namely selected in terms of absolute average, i.e., the set the average of which is largest in magnitude. The average value of this largest set is then coded along with identification information as information on the current parameterization update, the identification information identifying the coded set of parameters of the parameterization, namely the ones the corresponding update value of which is included in the largest set. In other words, each round or cycle, either the largest (or positive) update values are coded, or the lowest (negative) update values are coded. Thereby, a signaling of any sign information for the coded update values in addition to the average value coded for the coded update values is unnecessary, thereby saving signaling overhead even further. The inventors of the present application have found that toggling or alternating between signaling highest and lowest update value sets in lossy coding consecutive parameterization updates in a distributed learning scenario—not in a regular sense, but in a statistical sense as the selection depends on the training data—does not significantly impact the learning convergence rate, while the coding overhead is significantly reduced. This holds true both when applying coding loss accumulation with lossy coding the accumulated prediction updates, or coding the parameterization updates without coding loss accumulation.

As should have become readily clear from the above brief outline of the aspects of the present application, these aspects, although being advantageous when implemented individually, may also be combined pairwise, in triplet or all of them.

### BRIEF DESCRIPTION OF THE DRAWINGS

Embodiments of the present application are described below with respect to the figures among which:

FIG. 1 shows a schematic diagram illustrating a system or arrangement for distributed learning of a neural network composed of clients and a server, wherein the system may be embodied in accordance with embodiments described herein, and wherein each of the clients individually and the server individually may be embodied in the manner outlined in accordance with subsequent embodiments;

FIG. 2 shows a schematic diagram illustrating an example for a neural network and its parameterization;

FIG. 3 shows a schematic flow diagram illustrating a distributed learning procedure with steps indicated by boxes which are sequentially arranged from top to bottom and arranged at the right hand side if the corresponding step is performed at client domain, arranged at the left hand side if the corresponding step is up to the server domain whereas boxes shown as extending across both sides indicate that the corresponding step or task involves respective processing at server side and client side, wherein the process depicted in FIG. 3 may be embodied in a manner so as to conform to embodiments of the present application as described herein;

FIG. 4a-c show block diagrams of the system of FIG. 1 in order to illustrate the data flow associated with individual steps of the distributed learning procedure of FIG. 3;

FIG. 5 shows, in form of a pseudo code, an algorithm which may be used to perform the client individual training, here exemplarily using stochastic gradient descent;

FIG. 6 shows, in form of a pseudo code, an example for a synchronous implementation of the distributed learning according to FIG. 3, which synchronous distributed learning may likewise be embodied in accordance with embodiments described herein;

FIG. 7 shows, by way of a pseudo code, a concept for distributed learning using parameterization updates transmission in upload and download direction with using coding loss awareness and accumulation for a speed-up of the learning convergence or an improved relationship between convergence speed on the one hand and data amount to be spent for the parameterization update transmission on the other hand;

FIG. 8 shows a schematic diagram illustrating a concept for performing the lossy coding of consecutive parameterization updates in a coding loss aware manner with accumulating previous coding losses, the concept being suitable and the advantages to be used in connection with download and upload of parameterization updates, respectively;

FIG. 9a-d show, schematically, the achieved compression gains when using sparsity enforcement according to an embodiment of the present application called sparse binary compression with here, exemplarily, also using a lossless entropy coding for identifying the coded set of update values in accordance with an embodiment;

FIG. 10 shows from left to right for six different concepts of coding parameterization update values for a parameterization of a neural network the distribution of these update values with respect to their spatial distribution across a layer using gray shading for indicating the coded values of these update values, and with indicating there below the histogram of coded values, and with indicating above each histogram the resulting coding error resulting from the respective lossy coding concept;

FIG. 11 shows schematically a graph of the probability distribution of an absolute value of a gradient or parameterization update value for a certain parameter;

FIGS. 12-17 show experimental results resulting from designing distributed learning environments in different manners, thereby proving the efficiency of effects emerging from embodiments of the present application;

FIG. 18 shows a schematic diagram illustrating a concept for lossy coding of consecutive parameterization updates using sparse binary compression in accordance with an embodiment; and

FIG. 19 shows a schematic diagram illustrating the concept of lossy coding consecutive parameterization updates using entropy coding and probability distribution estimation based on an evaluation or preceding coding losses.

### DETAILED DESCRIPTION

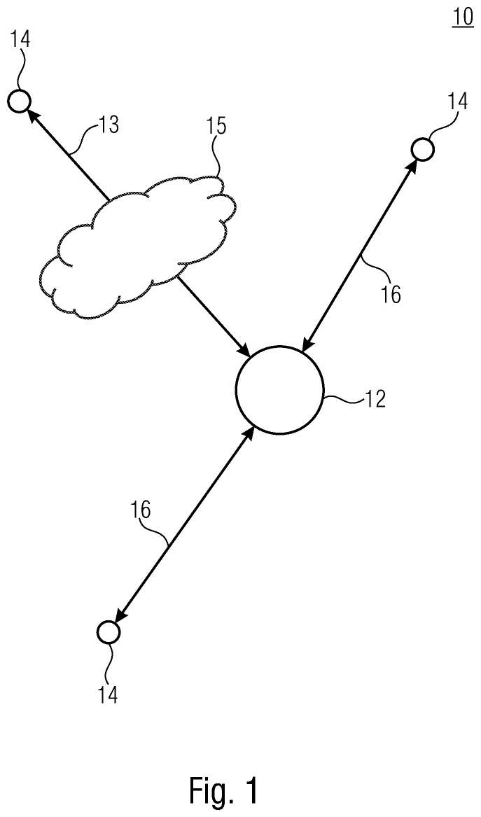

Before proceeding with the description of embodiments of the present application with respect to the various aspects of the present application, the following description briefly presents and discusses general arrangements and steps involved in a distributed learning scenario. FIG. 1, for instance, shows a system 10 for distributed learning of a parameterization of a neural network. FIG. 1 shows the system 10 as comprising a server or central node 12 and several nodes or clients 14. The number M of nodes or clients 14 may be any number greater than one although three are shown in FIG. 1 exemplarily. Each node/client 14 is connected to the central node or server 12, or as connectable thereto, for communication purposes as indicated by respective double headed arrow 13. The network 15 via which each node 14 is connected to server 12 may be different for the various nodes/clients 14 or may be partially the same. The connection 13 may be wireless and/or wired. The central node or server 12 may be a processor or computer and coordinates in a manner outlined in more detail below, the distributed learning of the parameterization of a neural network. It may distribute the training workload onto the individual clients 14 actively or it may simply behave passively collect the individual parameterization updates. It then merges the updates obtained by the individual trainings performed by the individual clients 14 with redistributing the merge parameterization update onto the various clients. The clients 14 may be portable devices or user entities such as cellular phones or the like.

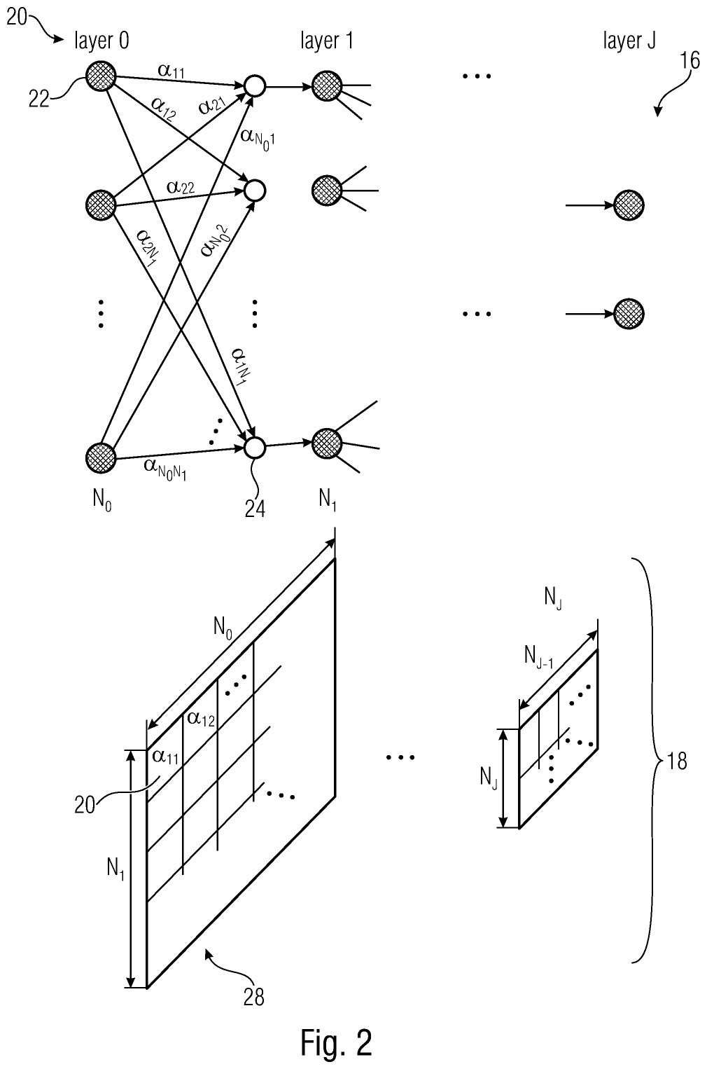

FIG. 2 shows exemplarily a neural network 16 and its parameterization 18. The neural network 16 exemplarily depicted in FIG. 2 shall not be treated as being restrictive to the following description. The neural network 16 depicted in FIG. 2 is a non-recursive multi-layered neural network composed of a sequence of layers 20 of neurons 22, but neither the number J of layers 20 nor the number of neurons 22, namely Nⱼ, per layer j, 20, shall be restricted by the illustration in FIG. 2 just. Also the type of the neural network 16 referred to in the subsequently explained embodiments shall not be restricted to any of neural networks. FIG. 2 illustrates the first hidden layer, layer 1, for instance, as a fully connected layer with each neuron 22 of this layer being activated by an activation which is determined by the activations of all neurons 22 of the preceding layer, here layer zero. However, this is also merely illustrative, and the neural network 16 may not be restricted to such layers. As an example, the activation of a certain neuron 22 may be determined by a certain neuron function 24 based on a weighted sum of the activations of certain connected predecessor neurons of the preceding layer with using the weighted sum as an attribute of some non-linear function such as a threshold function or the like. However, also this example shall not be treated as being restrictive and other examples may also apply. Nevertheless, FIG. 2 illustrates the weights α_{i, j} at which activations of neurons i of a preceding layer contribute to the weighted sum for determining, via some non-linear function, for instance, the activation of a certain neuron j of a current layer and these weights 26, thus, form a kind of matrix 28 of weights which, in turn, is comprised by the parameterization 18 in that same describes the parameterization of the neural network 16 with respect to this current layer. Accordingly, as depicted in FIG. 2, the parameterization 18 may, thus, comprise a weighting matrix 28 for all layers 1 . . . J of the neural network 16 accept the input layer, layer 0, the neural nodes 22 of which receive the neural network's 16 input which is then subject by the neural network 16 to the so-called prediction and mapped onto the neural nodes 22 of layer J—which form kind of output nodes of the network 16—or the one output node if merely one node is comprised by the last layer J. Alternatively, the parameterization 18 may additionally or alternatively comprise other parameters such as, for instance, the aforementioned threshold of the non-linear function or other parameters.

Just as a side, it is noted that the input data which the neural network 16 is designed for, may be picture data, video data, audio data, speech data and/or textural data and the neural network 16 may be, in a manner outlined in more detail below, ought to be trained in such a manner that the one or more output nodes are indicative of certain characteristics associated with this input data such as, for instance, the recognition of a certain content in the respective input data, the prediction of some user action of a user confronted with the respective input data or the like. A concrete example could be, for instance, a neural network 16 which, when being fed with a certain sequence of alphanumeric symbols typed by a user, suggesting possible alphanumeric strings most likely wished to be typed in, thereby attaining an auto correction and/or auto-finishing function for a user-written textual input, for instance.

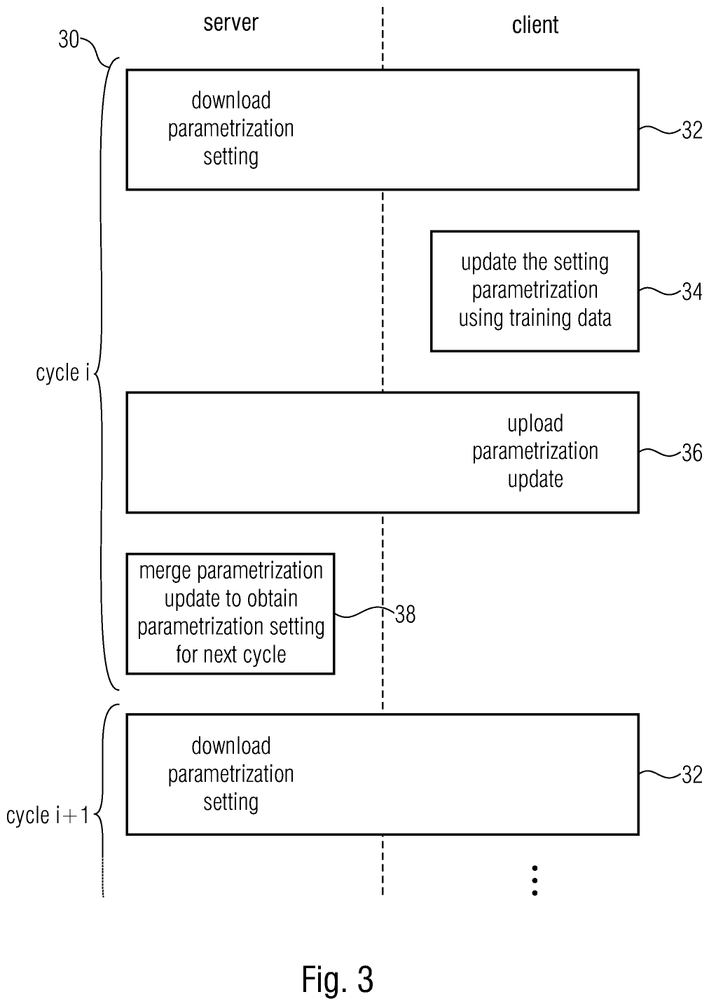

FIG. 3 shows a sequence of steps performed in a distributed learning scenario performed by the system of FIG. 1, the individual steps being arranged according to their temporal order from top to bottom and being arranged at the left hand side or right hand side depending on whether the respective step is performed by the server 12 (left hand side) or by the clients 14 (right hand side) or involves tasks at both ends. It should be noted that FIG. 3 shall not be understood as entailing that the steps are performed in a manner synchronized with respect to all clients 14. Rather, FIG. 3 indicates, in so far, the general sequence of steps for one client-server relationship/communication. With respect to the other clients, the server-client cooperation is the structured in the same manner, but the individual steps not necessarily occur concurrently and even the communications from server to clients need not to carry exactly the same data, and/or the number of cycles may vary between the clients. For sake of an easier understanding, however, these possible variations between the client-server communications are not further specifically discussed hereinafter.

As illustrated in FIG. 3, the distributed learning operates in cycles 30. A cycle i is shown in FIG. 3 to start with a download, from the server 12 to the clients 10, of a setting of the parameterization 18 of the neural network 16. The step 32 of the download is illustrated in FIG. 3 as being performed on the side of the server 12 and clients 14 as it involves a transmission or sending on the side of the server 12 and a reception on the side of clients 14. Details with respect to this download 32 will be set out in more detail below as, in accordance with embodiments of the present application in accordance with certain aspects, this download may be performed in a certain specific manner which increases the efficiency of the distributed learning. For instance, the setting may be downloaded in form of an update (merged parametrization update) of the previous cycle's setting rather than anew for each cycle.

The clients 14 receive the information on the parameterization setting. The clients 14 are not only able to parameterize an internal instantiation of the neural network 16 accordingly, i.e., according to this setting, but the clients 14 are also able to train this neural network 16 thus parametrized using training data available to the respective client. Accordingly, in step 34, each client trains the neural network, parameterized according to the downloaded parameterization setting, using training data available to the respective client at step 34. In other words, the respective client updates the parameterization setting using the training data. Depending on whether the distributed learning is a federated learning or data-parallel learning, the source of the training data may be different: in case of federated learning, for example, each client 14 gathers its training data individually or separately from the other clients or at least a portion of its training data is gathered by the respective client in this individual manner while a reminder is gained otherwise such as be distribution by the server as done in data-parallel learning. The training data may, for example, be gained from user inputs at the respective client. In case of data-parallel learning, each client 14 may have received the training data from the server 12 or some other entity. That is, the training data then does not comprise any individually gathered portion. The splitting-up of a reservoir of training data into portions may be done evenly in terms of, for instance, amount of data and statistics of the data. Details in this regard are set out in more detail below. Most of the embodiments described herein below, may be used in both types of distributed learning so that, unless otherwise stated, the embodiments described herein below shall be understood as being not specific for either one of the distributed learning types. As outlined in more detail below, the training 34 may, for instance, be performed using a stochastic gradient decent method. However, other possibilities exist as well.

Next, each client 14 uploads its parameterization update, i.e., the modification of the parameterization setting downloaded at 32. Each client, thus, informs the server 12 on the update. The modification results from the training in step 34 performed by the respective client 14. The upload 36 involves a sending or transmission from the clients 14 to server 12 and a reception of all these transmissions at server 12 and accordingly, step 36 is shown in FIG. 3 as a box extending from left to right just as the download step 32 is.

In step 38, the server 12 then merges all the parameterization updates received from the clients 14, the merging representing a kind of averaging such as by use of a weighted average with the weights considering, for instance, the amount of training data using which the parameterization update of a respective client has been obtained in step 34. The parameterization update thus obtained at step 38 at this end of cycle i indicates the parameterization setting for the download 32 at the beginning of the subsequent cycle i+1.

As already indicated above, the download 32 may be rendered more efficient and details in this regard are described in more detail below. One such task is, for instance, the performance of the download 32 in a manner so that the information on the parameterization setting is downloaded to the clients 14 in form of a prediction update or, to be more precise, merged parameterization update rather than downloading the parameterization setting again completely. While some embodiments described herein below relate to the download 32, others relate to the upload 36 or may be used in connection with both transmissions of parameterization updates. Insofar, FIG. 3 serves as a basis and reference for all these embodiments and descriptions.

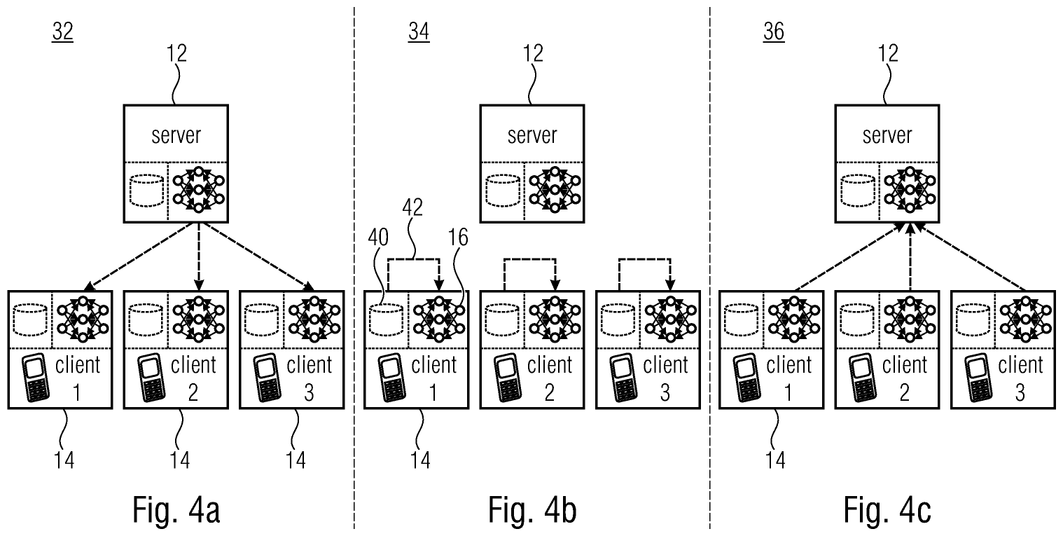

After having described the general framework of distributed learning, examples with respect to the neural networks which may form the subject of the distributed learning, the steps performed during such distributed learning and so forth, the following description of embodiments of the present application starts with a presentation of an embodiment dealing with federated learning which makes use of several of the aspects of the present application in order to provide the reader with a sort of overview of the individual aspects and an outline of their advantages, thereby rendering easier the subsequent description of embodiments which form kind of generalizations of this outline. Thus, the description brought forward first concerns a particular training method, namely the federated learning as described, for instance, in [2]. Here, it is proposed to train neural networks 16 in the distributed setting in the manner outlined with respect to FIG. 3, namely by
1) Each node/client 14 downloads 32 the parameterization 18 of the neural network 16 from the central node or server 12 with the resulting dataflow from server 12 to clients 14 being depicted in FIG. 4a.
2) The downloaded network's parameterization 18 or the network 16 thus parameterized is then trained 34 locally at each node/client 14 for T iterations such as via stochastic gradient decent. See, for instance, FIG. 4b which illustrates that each client 14 has a storage 40 for storing the training data and uses this training data as depicted by a dashed arrow 42 to train its internal instantiation or the neural network 16.
3) Then, all nodes/clients 14 upload 36 the parameter changes or parameterization updates of the neural network 16 to the central node 12. The parameterization update or change is also called “gradient” in the following description as the amount of parameterization update/change per cycle indicates for each parameter of the parameterization 18 a strength of a convergence speed at a current cycle, i.e., the gradient of the convergence. FIG. 4c shows the upload.
4) Then, the central node 12 merges the parameterization updates/changes such as by taking the weighted average of these changes, which merging corresponds to step 38 of FIG. 3.
5) Steps 1 to 4 are then repeated for N communication rounds, for instance, or until convergence, or are continuously performed.

Extensive experiments have shown that one can accurately train neural networks in a distributed setting via the federated learning procedure. In Federated learning, the training data and computation resources are, thus, distributed over multiple nodes 14. The goal is to learn a model from the joint training data of all nodes 14. One communication round 30 of synchronized distributed SGD consists of the steps of (FIG. 4a) download, (FIG. 4b) local weight-update computation, (FIG. 4c) upload, followed by global aggregation. It is important to note that only weight-updates and no training-data needs to communicated in distributed SGD.

However, usually, in order to accurately train a neural network via the federated learning method, many communication rounds 30 (that is, many download and upload steps) are used. This implies that the method can be very inefficient in practice if the goal is to train large and deep neural networks (which is usually the desired case). For example, standard deep neural networks which solve state of the art computer vision tasks are around 500 MB in size. Extended experiments have confirmed that the federated learning uses at least 100 communication rounds to solve these computer vision tasks. Hence, in total, we would have to send/receive at least 100 GB (=2×100×500 MB) during the entire training procedure. Hence, reducing the communication cost is critical for being able to make use of this method in practice.

A possible solution for solving this communication inefficiency is to lossy compress the gradients and upload/download a compressed version of the change of the neural network [6]. However, the compression induces quantization noise into the gradients, which decreases the training efficiency of the federated learning method (either by decreasing the accuracy of the network or using a higher number of communication rounds). Hence, in the standard federated learning we face this efficiency-performance bottleneck, which hinders its practicality for real case scenarios.

Considering the above-mentioned drawbacks, the embodiments and aspects described further below individually or together solve the efficiency-performance bottleneck in the following manner.
1) The training procedure is modified in a manner which allows to dramatically lossy compress during the upload communication step 36, for instance, the gradients without significantly affecting the training performance of the network when using federated learning.
2) We modify the training procedure in a manner which allows us to dramatically compress the gradients during the download communication step 32 without (significantly) effecting the training performance of the network irrespective of the distributed learning being of the federated type or not. The achievements mentioned in 1 and 2 are attained by introducing an accumulation step where the compression error is accumulated locally at the sender side, i.e., at the respective client 14 in case of the upload communication step 36 and at the central node or server 12 when used in the download communication step 32, and the accumulated compression error (coding loss) is added to the actual state to be transmitted at the respective communication round, possibly using some weighted summation). The advantage of doing so is that this allows us to drastically reduce the signal to noise ratio of the gradients induced by the compression noise, i.e., of the parameterization update.
3) In accordance with a further aspect, the communication cost is further reduced by applying a lossless compression technique on top of the lossy compression of the gradients—might it be the upload parameterization updates or the merged parameterization update sent during download 32. Here, the design of an efficient lossless codec may take advantage of prior knowledge regarding the training procedure employed.
4) And even further, the coding or compression loss may be chosen very efficiently when restricting the transmission of a parameterization update—be it in upload or download—onto a coded set of update values (such as the largest ones) with representing same using an average value thereof. Smart gradient compression (SGC) and sparse binary compression (SBC) are presented in the following. The concept is especially effective if the restriction focusses on a largest set of upload values for a coded set of parameters of the parameterization 18, the largest set being either a set comprising a predetermined number of highest upload values, or a set made up of the same predetermined number of lowest update values so that the transmission of individual sign information for all these update values is not necessary. This corresponds to SBC. The restriction does not significantly impact the learning convergence rate as non-transmitted update values due to being in the second but largest set of update values of opposite sign are likely to be transmitted in one of the cycles to come.

Using the above concepts individually or together we are able to reduce the communication costs by a high factor. When using them all together, for instance, the communication cost reduction may be of a factor of at least 1000 without affecting the training performance in some of the standard computer vision tasks.

Before starting with a description of embodiments which relate to federated learning while then subsequently broadening this description with respect to certain embodiments of the various aspects of the present application, the following section provides some description with respect to neural networks and their learning thereof in general with using mathematical notations which will subsequently be used.

On the highest level of abstraction, a Deep Neural Network (DNN), which network 16 may represent, is a function

ƒ_{W}: [symbol] ^{S}^{ᵢₙ}→ [symbol] ^{S}^{ₒᵤₜ},x [symbol] ƒ_{W}(x) (1)

that maps real-valued input tensors x (i.e., the input applied onto the nodes of the input layer of the neural network 16) with shape Sᵢₙ to real-valued output tensors of shape Sₒᵤₜ (i.e., the output values or activations resulting after prediction by the neural network 16 at the nodes of the output layer, i.e., layer J in FIG. 2, of the neural network 16). Every DNN is parameterized by a set of weights and biases W (we will use the terms “weights” and “parameters” of the network synonymously in the following). The weights of parameters were indicated using the alphanumeric value α in FIG. 2. The number of weights |W| can be extremely large, with modern state-of-the-art DDN architectures usually having millions parameters. That is, the size of the parameterization 18 or the numbers of parameters comprised thereby may be huge. In supervised learning, we are given a set of data-points x₁, . . . , xₙ∈ [symbol] ^{S}^{ᵢₙ} and a set of corresponding desired outputs of the network y₁, . . . , yₙ∈ [symbol] ^{S}^{ₒᵤₜ}. We can measure how closely the DNN matches the desired output with a differentiable distance measure

dist_{W}: [symbol] ^{S}^{ₒᵤₜ}× [symbol] ^{S}^{ₒᵤₜ}→ [symbol] . (2)

The goal in supervised learning is to find parameters W, a setting for the parameterization 18, for which the DNN most closely matches the desired output on the training data D={(xᵢ, yᵢ)|=1, . . . , n}, i.e. to solve the optimization problem

$$\begin{matrix}{W}^{*} = arg {min}_{W} l ( W , D ) \\ with & ( 3 ) \\ l ( W , D ) = \frac{1}{\vert D \vert} {\sum }_{( {x}_{i} , {y}_{i} ) ∈ D} dist ( {f}_{W} ( {x}_{i} ) , {y}_{i} ) . & ( 4 )\end{matrix}$$

being called the loss-function. The hope is that model W*, resulting from solving optimization problem (3), will also generalize well to unseen data \hat{D} that is disjoint from the data D used for training, but that follows the same distribution. The generalization capability of any machine learning model generally depends heavily on the amount of available training-data.

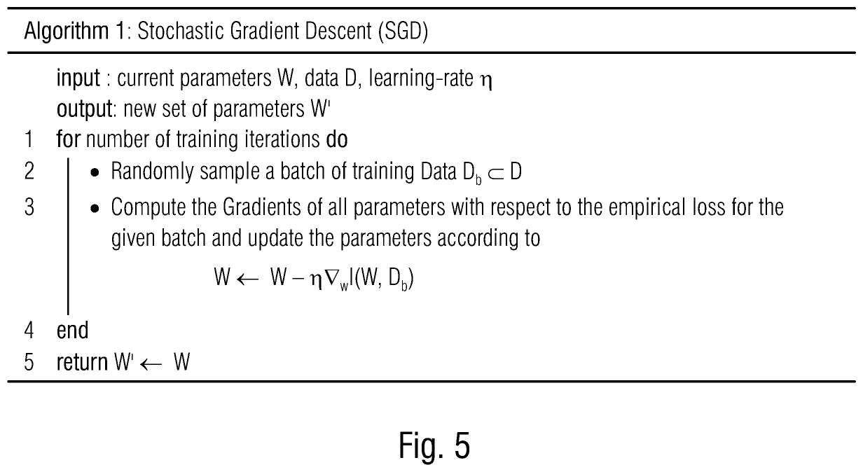

Solving the problem (3) is highly non trivial, because the i is usually non-linear, non-convex and extremely high-dimensional. The by far most common way to solve (3) is to use an iterative optimization technique called stochastic gradient descent (SGD). The algorithm for vanilla SGD is given in FIG. 5. This algorithm or SGD method may be used, for instance, by the clients 14 during the individual training at 34. The random sample of a batch of training data might be, however, realized at each client 34 automatically by gathering the training data individually at the respective client and independent from other clients as will be outlined in more detail below. The randomness may be designed more evenly in case of data-parallel learning as already briefly stated above and further mentioned below.

While many adaptations to the algorithm of FIG. 5 have been proposed, that can speed up the converge (momentum optimization, adaptive learning rate), they all follow the same principle: We can invest computational resources (measured e.g. by the number of training iterations) to improve the current model using data D

W′=SGD(W,D,θ) (5)

with θ being the set of all optimization-specific hyperparameters (such as the learning-rate or the number of iterations). The quality of the improvement usually depends both on the amount of data available and on the amount of computational resources that is invested.

The weights and weight-updates are typically calculated and stored in 32-bit floating-point arithmetic.

In many real world scenarios the training data D and computational resources are distributed over a multitude of entities (we are called “clients” 14 in the following). This distribution of data and computation can either be a intrinsic property of the problem setting (for example because the data is collected and stored on mobile or embedded devices) or it can be willingly induced by a machine learning practitioner (i.e. to speed up computations via a higher level of parallelism). The goal in distributed training is to train a global model, using all of the clients training data, without sending around this data. This is achieved by performing the following steps: Clients that want to contribute to the global training first synchronize with the current global model, by downloading 32 it from a server. They then compute 34 a local weight-update using their own local data and upload 36 it to the server. At the server all weight-updates are aggregated 38 to form a new global model.

Below, we will give a short description of two typical settings in which distributed Deep Learning occurs:

Federated Learning: In the Federated Learning setting the clients 14 are embodied as data-collecting mobile or embedded devices. Already today, these devices collect huge amounts of data, that could be used to train Deep Neural Networks. However this data is often privacy sensitive and therefore can not be shared with a centralized server (private pictures or text-messages on a user's phone, . . . ). Distributed Deep Learning enables training a model with the shared data of all clients 14, without any of the clients having to reveal the their training data to a centralized server 12. While information about the training data could theoretically be inferred from the parameter updates, [3] show that it is possible to come up with a protocol that even conceals these updates, such that is possible to jointly train a DNN without compromising the privacy of the contributors of the data at all. Since the training data on a given client will typically be based on the usage of the mobile device by it's user, the distribution of the data among the clients 14 will usually be non-iid and any particular Userâ€™s local dataset will not be representative of the whole distribution. The amount of data will also typically be unbalanced, since different users make use of a service or app to different extent, leading to varying amounts of local training data. Furthermore, many scenarios are imaginable in which the total number of clients participating in the optimization can be much larger than the average number of examples per client. In the Federated Learning setting communication cost is typically a crucial factor, since mobile connections are often slow, expensive and unreliable.

Data-Parallel Learning: Training modern neural network architectures with millions of parameters on huge data-sets such as ImageNet [4] can take a very long time, even on the most high-end hardware. A very common technique to speed up training, is to make use of increased data-parallelism by letting multiple machines compute weight-updates simultaneously on different subsets of the training data. To do so, the training data D is split over all clients 14 in an even and balanced manner, as this reduces the variance between the individual weight-updates in each communication round. The splitting may be done by the server 12 or some other entity Every client in parallel computes a new weight-update on it's local data and the server 12 then averages over all weight-updates. Data-parallel training is the most common way to introduce parallelism into neural network training, because it's very easy to implement and has great scalability properties. Model-parallelism in contrast scales much worse with bigger datasets and is tedious to implement for more complicated neural network architectures. Still, the amount of clients in data-parallel training is relatively small compared to federated learning, because the speed-up achievable by parallelization is limited by the non-parallelizable parts of the computation, most prominently the communication used after each round of parallel computation. For this reason, reducing the communication time is the most crucial factor in data-parallel learning. On a side-note, if the local batch-size and the number of local iterations is equal to one for all clients, one communication round of data-parallel SGD is mathematically equivalent to one iteration of regular SGD with a batch-size equal to the number of participating clients.

We systematically compare the two settings in the subsequent table.

| Federated Learning | | Data-Parallel Learning |
|---|---|---|
| Clients are mobile or embedded | ↔ | Clients are individual GPUs in a |
| devices | | cluster |
| The number of Clients is | ↔ | The number of Clients is relatively |
| potentially huge | | small |
| The hardware of the Clients is | ↔ | The hardware of the Clients is |
| very limited | | strong |
| The Clients connection is slow, | ↔ | The Clients connection is relatively |
| unreliable and expensive | | fast, reliable and free |
| The data is client-specific, | ↔ | The data is balanced, i.i.d., not |
| non-i.i.d., unbalanced, privacy | | privacy sensitive |
| sensitive | | |
| The goal is to train a joint | ↔ | The goal is to train a neural network |
| model on the combined training | | as fast as possible, making use of |
| data of all clients, without | | the increased data-parallelism |
| compromising the participants | | |
| privacy | | |

The above table compares the two main settings in which training from distributed data occurs. These two settings form the two ends of the spectrum of situations, in which learning from distributed data occurs. Many scenarios that lay in between these two extremes are imaginable.

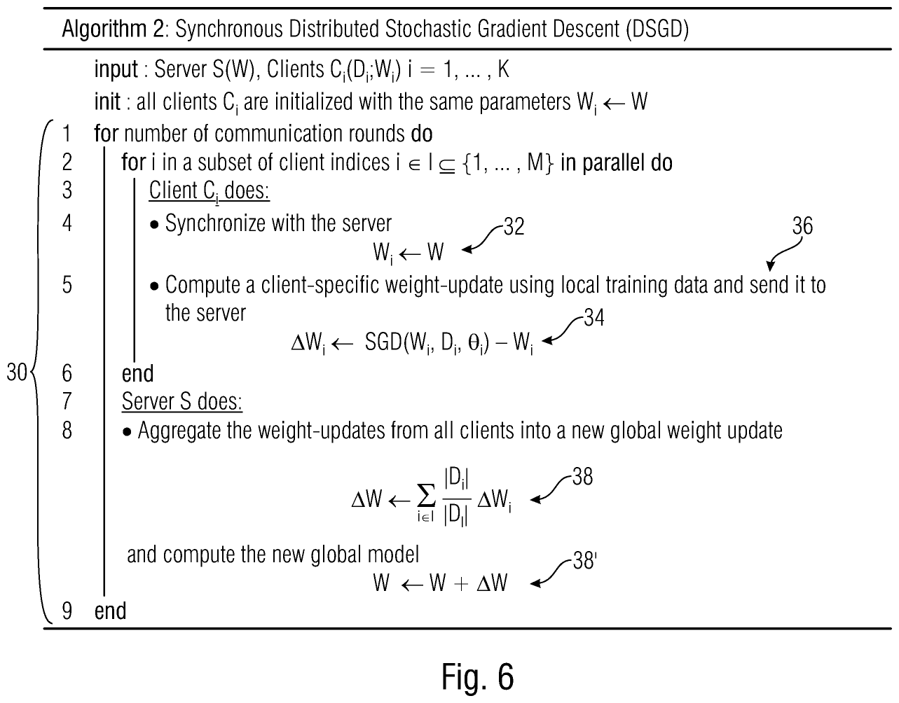

Distributed training as described above may be performed in a synchronous manner. Synchronized training has a benefit in that it ensures that no weight update is outdated at the time it arrives at the server. Outdated weight-updates may otherwise destabilize the training. Therefore, synchronous distributed training might be performed, but the subsequently described embodiments may also be different in this regard. We describe the general form of Synchronous Distributed SGD in FIG. 6. In each communication round 30, every client 14 performs the following operations: First, it downloads the latest model from the server. Second, it computes 34 a local weight-update based on it's local training data using a fixed amount of iteration of SGD, starting at the global model W. Third, it uploads 36 the local weight-update to the server 12. The server 12 then accumulates 38 the weight updates from all participating clients, usually by weighted averaging, applies 38′ them to the global model to obtain the new parametrization setting and then broadcasts the new global model or setting back to all clients at the beginning of the cycle 30 at 32 to ensure that everything remains synchronized.

During every communication round or cycle of synchronous distributed SGD every client 14 should once download 32 the global model (parametrization setting) from the server 12 and later upload 36 it's newly computed local weight-update back to the server 12. If this is done naively, the amount of bits that have to be transferred at up- and download can be severe. Imagine a modern neural network 16 with 10 million parameters is trained using synchronous distributed SGD. If the global weights W and local weight-updates ΔWᵢ are stored and transferred as 32 bit floating point numbers, this leads to 40 MB of traffic at every up- and download. This is much more than the typical data-plan of a mobile device can support in the federated learning setting and can cause a severe bottleneck in Data-Parallel learning that significantly limits the amount of parallelization possible.

An impressive amount of scientific work has been published in the last couple of years that investigates ways to reduce the amount of communication in distributed training. This underlines the relevance of the problem.

[8] identifies the problem setting of Federated Learning and proposes a technique called Federated Averaging to reduce the amount of communication rounds used to achieve a certain target accuracy. In Federated Averaging, the amount of iterations for every client is increased from one single iteration to multiple iterations. The authors claim that their method can reduce the number of communication rounds used by a factor of 10×-100× on different convolutional and recurrent neural network architectures.

The authors of [10] propose a training scheme for federated learning with iid data in which the clients only upload a fraction of their local gradients with the biggest magnitude and download only the model parameters that are most frequently updated. Their method results in a drop of convergence speed and final accuracy of the trained model, especially at higher sparsity levels.

In [6], the authors investigate structured and sketched updates as a means to reduce the amount of communication in Federated Averaging. For structured updates, the clients are restricted to learn low-rank or sparse updates to their weights. For sketches updates, the authors investigate random masking and probabilistic quantization. Their methods can reduce the amount of communication used by up to two orders of magnitude, but also incur a drop in accuracy and convergence speed.

In [7], the authors demonstrate that it is possible to achieve up to 99.9% percent of gradient sparsity in the upload for the Data-Parallel Learning setting on modern architectures. They achieve this by only sending 0.1% of gradients with the biggest magnitude and accumulating the rest of the gradients locally. They additionally apply four tricks to ensure that their method does not slow down the convergence or reduce the final amount of accuracy achieved by the model. These tricks include using a curriculum to slowly increase the amount of sparsity in the first couple communication rounds and applying momentum factor masking to overcome the problem of gradient staleness. The report results for modern convolutional and recurrent neural network architectures on big data-sets.

In [1], a “Deep Gradient Compression” concept is presented, but use of the additional four tricks is made. Consequently their method entails a loss in convergence speed and final accuracy.

Paper [12] proposes to stochastically quantize the gradients to 3 ternary values. By doing so a moderate compression rate of approximately ×16 is achieved, while accuracy drops marginally on big modern architectures. The convergence of the method is mathematically proven under the assumption of gradient-boundedness.

In [9], the authors show empirically that it is possible to quantize the weight-updates in distributed SGD to 1 bit without harming convergence speed, if the quantization errors are accumulated. The authors report results on a language-modeling task, using a recurrent neural network.

In [2], Qsgd (Communication-efficient sgd) is presented. QSGD explores the trade-off between accuracy and gradient precision. The effectiveness of gradient quantization is justified and the convergence of QSGD is proven.

In an approach presented in [11], only gradients with a magnitude greater than a certain predefined threshold are sent to the server. All other gradients are aggregated in a residual.

Other authors such as in [5] and [14] investigated the effects of reducing the precision of both weights and gradients. The results they get are considerably worse than the ones achievable if only the weight-updates are compressed.

The framework presented below relies on the following observations:
The weight-updates ΔW, i.e., the parameterization updates, are very noisy: If the training data is split disjointly into K batches ∪ᵢ₌₁^{K} Dᵢ=D then from equation (4) it follows that

$$l ( W , D ) = {Σ}_{i = 1 , … , K} \frac{\vert {D}_{i} \vert}{\vert D \vert} l ( W , {D}_{i} ) \qquad ( 6 )$$

therefore the stochastic gradient is a noisy approximation of the true gradient

$$\begin{matrix}{∇}_{W} l ( {D}_{i} , W ) = {∇}_{w} l ( D , W ) + {N}_{i} \\ with & ( 7 ) \\ {Σ}_{i} \frac{\vert {D}_{i} \vert}{\vert D \vert} {N}_{i} = 0 & ( 8 )\end{matrix}$$

It is verified through experiments and theoretical considerations, that the noise present in SGD is actually helpful during training, because it helps the gradient descent not to get stuck in a bad local minimum.
Since stochastic gradients are noisy anyway, it is not necessary to transfer the weight-updates exactly. Instead it is possible to compress the weight-updates lossy, without causing significant harm to the convergence speed. Compression, such as quantization or sparsification can interpreted as a special form of noise. In the new compressed setting, the clients upload

Δ\tilde{W}ᵢ=compress(ΔWᵢ) (9)
instead of ΔWᵢ.
Instead of downloading the full model W at every communication round or cycle, we can instead just download the global weight-update ΔW and then apply this weight update locally. This is mathematically equivalent to the former approach, if the client was already synchronized with the server in the previous communication round, but has the big benefit that it enables us to make use of the same compression techniques we were using in upload also in download. Thus, the client may download

Δ\tilde{W}=compress(ΔW) (10)
instead of ΔW.
It is beneficial to the convergence, if the error that is made by compressing the weight-updates is accumulated locally. This finding can be naturally integrated into our framework.

Aᵢ←αAᵢ+ΔWᵢ (11)

Δ\tilde{W}ᵢ←compress_{C}(Aᵢ) (12)

Aᵢ←Aᵢ−Δ\tilde{W}ᵢ (13)
The parameter α controls the amount of accumulation (typically α∈{0,1}).
We identify efficient encoding and decoding of the compressed weight-updates as a factor of significant importance to compression. Making use of statistical properties of the weight-updates enables further reduction of the amount of communication via predictive coding. The statistical properties may include the temporal or spatial structure of the weight-updates. The framework also enables lossy encoding of the compressed weight-updates.

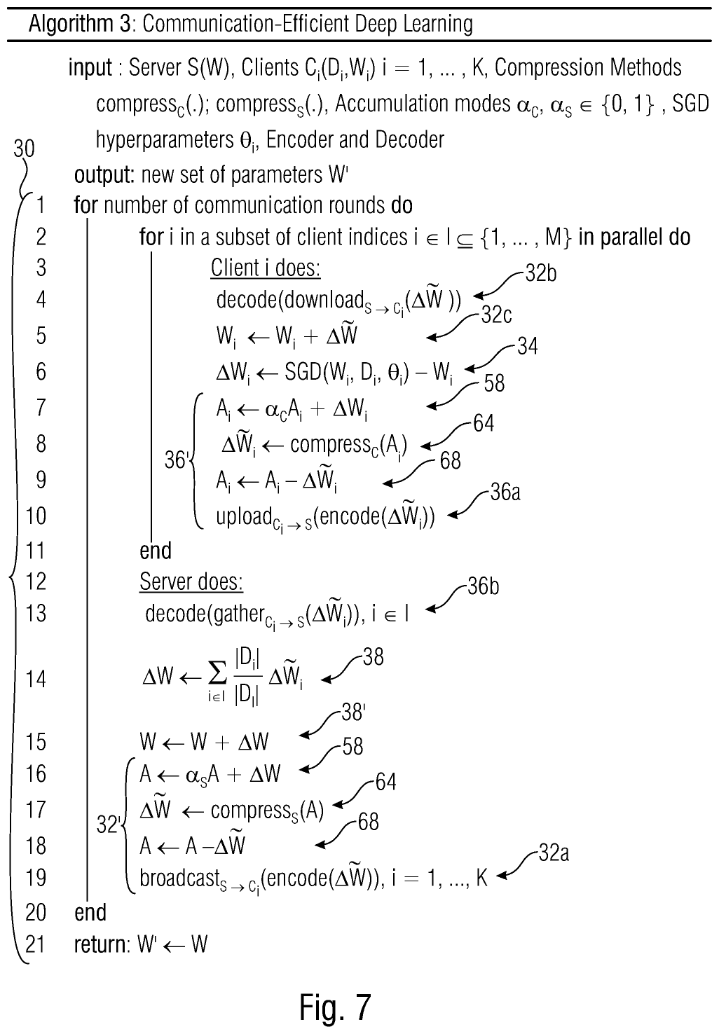

A framework which makes use of all of the above-discussed insights and concepts is shown in FIG. 7 and described in the following. In general, a mode of operation of the distributed learning concept of FIG. 7 is the same as the one described so far generally with respect to FIGS. 3 and 6. The specifics are as follows. For example, FIG. 7 shows in its pseudo code the download step 32 as being split-up into the reception 32b of the parameterization update Δ\tilde{W} and its transmission 32′. In particular, the parameterization setting download is restricted to a transmission of the (merged) parameterization update only. Each client, thus, completes the actual update of the parameterization setting download by internally updating the parameterization setting downloaded in the previous cycle with the currently downloaded parameterization update at 32c such as, as depicted in FIG. 7, by adding the currently downloaded parameterization update downloaded in the current cycle to the parameterization setting Wᵢ downloaded in the previous cycle. Each client uses its training data Dᵢ to further train the neural network and thereby obtains a new (locally updated) parameterization setting, thereby obtaining a parameterization update ΔWᵢ at step 34 such as, as illustrated in FIG. 7, by subtracting the newly trained parameterization setting and the parameterization setting which the respective client i recently became aware of at the current cycle's download 32.

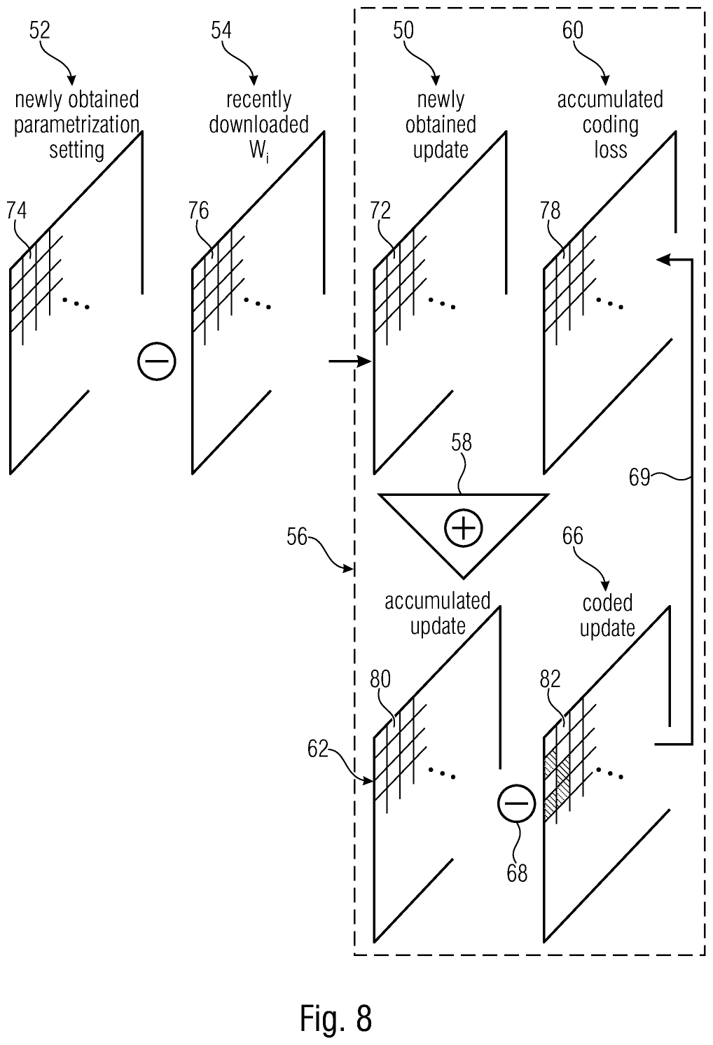

Each client uses lossy coding 36′ for the upload of the just-obtained parameterization update ΔWᵢ. To this end, each client i locally manages an accumulation of coding losses or coding errors of the parameterization update during preceding cycles. The accumulated sum of client i is indicated in FIG. 7 by Aᵢ. The concept of transmitting (or lossy coding) a parameterization update using coding loss accumulation, here currently used in the upload 36, is explained by also referring to FIG. 8. Later, FIG. 8 is revisited with respect to the download procedure 32. The newly obtained parameterization update is depicted in FIG. 8 at 50. In case of the parameterization update upload, this newly obtained parameterization update forms the difference between the newly obtained parameterization setting, i.e., the newly learned one indicated as SGD( . . . ) in FIG. 7, on the one hand and the recently downloaded parameterization setting Wᵢ on the other hand indicated at reference signs 52 and 54 in FIG. 8. The newly obtained parameterization update 50, i.e., the one of the current cycle, thus forms the input of the coding loss aware coding/transmission 36′ of this parameterization update, indicated at reference sign 56 in FIG. 8, and realized using code lines 7 to 9 in FIG. 7. In particular, an accumulation 58 between the current parameterization update 50 on the one hand and the accumulated coding loss 60 on the other hand is formed so as to result into an accumulated parameterization update 62. A weighting may control the accumulation 58 such as a weight at which the accumulated coding loss is added to the current update 50. The accumulation result 62 is then actually subject to compression or lossy coding at 64, thereby resulting into the actually coded parameterization update 66. The difference between the accumulated parameterization update 62 on the one hand and the coded parameterization update 66 on the other hand which difference is determined at 68 and forms the new state of the accumulated coding loss 60 for the next cycle or round as indicated by the feedback arrow 69. The coded parameterization update 66 is finally uploaded with no further coding loss at 36a. That is, the newly obtained parameterization update 50 comprises an update value 72 for each parameter 26 of the parameterization 18. Here, in case of the update, the client obtains the current parameterization update 50 by subtracting the recently downloaded parameterization setting 54 from the newly trained one 52, the latter settings 52 and 54 comprising a parameter value 74 and 76, respectively, for each parameter 26 of the parameterization 18. The accumulation of the coding loss, i.e., 60, called Aᵢ for client i in FIG. 7, likewise comprises an accumulation value 78 for each parameter 26 of the parameterization 18. These accumulation values 78 are obtained by subtracting 66 for each parameter 26, the accumulated update value 80 for the respective parameter 26 having been obtained by the accumulation 58 from the corresponding value 72 and 78 for this parameter 26 and the actual coded update value 82 in the actually coded parameterization update 66 for this parameter 26.

It should be noted that there are two sources for the coding loss: firstly, not all of the accumulated parameterization update values 80 are actually coded. For example, in FIG. 8, hatching shows positions of parameters in the coded parameterization update 66 for which the corresponding accumulated parameterization update value 80 is left non-coded. This corresponds to, for instance, setting the corresponding value to zero or some other predetermined value at the receiver of the coded parameterization update 66, here in case of the upload, the server 12. For these non-coded parameter positons, accordingly, the accumulated coding loss is, in the next cycle, equal to the corresponding accumulated parameterization update value 80. The leaving of update value 80 uncoded is called “sparsification” in the following.

Even the accumulated parameterization update values 80 comprised by the lossy coding, however, the positions of parameters 26 of which are indicated non-hatched in the coded parameterization update 66 in FIG. 8 are not losslessly coded. Rather, the actually coded update value 82 for these parameters may differ from the corresponding accumulated parameterization update value 80 due to quantization depending on the chosen lossy coding concept for which examples are described herein below. For the later non-hatched parameters, the accumulated coding loss 60 for the next cycle is obtained by subtraction 68, thus corresponds to the difference between the actually coded value 82 for the respective parameter and the accumulated parameterization update value 80 resulting from the accumulation 58.

The upload of the parameterization update as transmitted by the client i at 36a is completed by the reception at the server at 36b. As just-described: parameterization values left uncoded in the lossy coding 64 are deemed to be zero at the server.

The server then merges the gathered parameterization updates at 38 by using, as illustrated in FIG. 7, for instance, a weighted sum of the parameterization updates with weighting the contribution of each client i by a weighting factor corresponding to the fraction of its amount of training data Dᵢ relative to the overall amount of training data corresponding to a collection of the training data of all clients. The server then updates its internal parameterization setting state at 38′ and then performs the download of the merged parameterization update at 32. This is done, again, using coding loss awareness, i.e., using a coding loss aware coding/transmission 56 as depicted in FIG. 8 indicated by 32′ in FIG. 7. Here, the newly obtained or currently to be transmitted parameterization update 50 is formed by the current merge result, i.e., by the currently merged parameterization update ΔW as obtained at 38. The coding loss of each cycle is stored in the accumulated coding loss 60, namely A, and used for accumulation 58 with the currently obtained merge parameterization update 50 which accumulation result 62, namely the A as obtained at 58 during download procedure 32′, is then subject to the lossy coding 64 and so forth.

As a result of performing the distributed learning in the manner as depicted in FIG. 7, the following has been achieved:
1) In particular, a full general framework of communication efficient distributed training in a client/server setting is achieved.
2) According to the embodiment of FIG. 7, a compressed parameterization update transmission is not only used during upload, but compressed transmission is used for both for upload and download. This reduces the total amount of communication used per client by up to two orders of magnitude.
3) As will be outlined in more detail below, a sparsity-based compression or losing coding concept may be used that achieves a communication volume two times smaller than expected with only a marginal loss of convergence speed, namely by toggling between choosing only the highest (positive) update values 80 or merely the lowest (negative) update values to be included in the lossy coding.
4) Further, it is possible to enable weighting-off accuracy against upload compression-rate against down-load compression-rate to adapt to the task or circumstances at hand.
5) Further, the concept promotes making use of statistical properties of parameterization updates to further reduce the amount of communication by a predictive coding. The statistical properties may include the temporal or spatial structure of the weight updates. Lossy coding compressed parameterization updates is enabled.

In the following, some notes are made with respect to possibilities with respect to the determination as to which parameterization update values 80 should actually be coded and how they should be coded or quantized. Examples are provided and they may be used in the example of FIG. 7, but they may also be used in combination with another distributed learning environment as will be outlined hereinafter with respect to the announced and broadening embodiments. Again, the quantization and sparsification described next may be used in upload and download, in case of FIG. 7 or one of same. Accordingly, the quantization and/or sparsification described next may be done at client side or server side or both sides with respect to the client's individual parameterization update and/or the merged parameterization update.

In quantization, compression is achieved, by reducing the number of bits used to store the weight-update. Every quantization method Q is fully defined by the way it computes the different quantiles q and by the rounding scheme it applies.

\tilde{W}=quantize(W,q(W,m)),q(W,m)={q₁<q₂< . . . <qₘ} (14)

The rounding scheme can be deterministic

$$\begin{matrix}\text{quantize} ( {w}_{i} , q ) = \{ \begin{matrix}j , & if {w}_{i} - {q}_{j} < {q}_{j + 1} - {w}_{i} \\ j + 1 , & else\end{matrix} & ( 15 ) \\ if {q}_{j} \leq {w}_{i} < {q}_{j + 1} & ( 16 )\end{matrix}$$

or stochastic

$$\begin{matrix}\text{quantize} ( {w}_{i} , q ) = \{ \begin{matrix}j , & with probability p = \frac{{w}_{i} - {q}_{j}}{{q}_{j + 1} - {q}_{j}} \\ j + 1 , & with probability p = \frac{{q}_{j + 1} - {w}_{i}}{{q}_{j + 1} - {q}_{j}}\end{matrix} & ( 17 ) \\ iff {q}_{j} \leq {w}_{i} < {q}_{j + 1} & ( 18 )\end{matrix}$$

Possible Quantization schemes include
Uniform Quantization

$$q ( W ) = \{ min ( W ) + \frac{i}{n - 1} ( max ( W ) - min ( W ) ) \vert i = 0 , … , n - 1 \}$$

Balanced Quantization

$$q ( W ) = \{ {sor t ( W )}_{floor ( \frac{i}{n - 1} card ( W ) )} \vert i = 0 , … , n - 1 \}$$

Ternary Quantization as proposed by [12]

q(W)={−max(|W|),0,max(|W|)}

In sparsification, compression is achieved, by limiting the number of non-zero elements used to represent the weight-update. Sparsification can be view as a special case of quantization, in which one quantile is zero, and many values fall into that quantile. Possible sparsification schemes include
Random Masking: Every entry of the weight-update is set to zero with probability 1−p. This method was investigated in [6].

$${\tilde{w}}_{i} = \{ \begin{matrix}{w}_{i} & with probability p \\ 0 & with probability 1 - p\end{matrix} \qquad ( 19 )$$

Fixed Threshold Compression: A weight-update is only transferred if it's magnitude is greater than a certain predefined threshold. This method was investigated in [?] and extended to an adaptive threshold in [2].

$${\tilde{w}}_{i} = \{ \begin{matrix}{w}_{i} & if \vert {w}_{i} \vert > t \\ 0 & else\end{matrix} \qquad ( 20 )$$

Deep Gradient Compression: Instead of uploading the full weight-update ΔWᵢ in every communication round, only the p weight-updates with the biggest magnitude are transferred. The rest of the gradients is accumulated locally. This method is thoroughly investigated in [7] and [1]

$${\tilde{w}}_{i} = \{ \begin{matrix}{w}_{i} & if \vert {w}_{i} \vert > {sort ( \vert W \vert )}_{floor ( ( 1 - p ) card ( W ) )} \\ 0 & else\end{matrix} \qquad ( 21 )$$

Smart Gradient Compression Further reduction of the communication cost of Deep Gradient Compression may be achieved by quantizing the big values of W to zero bits. Instead of transferring the exact values and positions of the p weight-updates with the biggest value, we transfer only their positions and their mean value.

$${\tilde{w}}_{i} = \{ \begin{matrix}μ \cdot sign ( {w}_{i} ) & if {w}_{i} > {sort ( \vert W \vert )}_{floor ( ( 1 - p ) card ( W ) )} \\ 0 & else\end{matrix} \\ with \\ μ = \frac{1}{card ( W ) p} {\sum }_{j = ( 1 - p ) card ( W )}^{card ( W )} {sort ( \vert W \vert )}_{j} \qquad ( 22 )$$

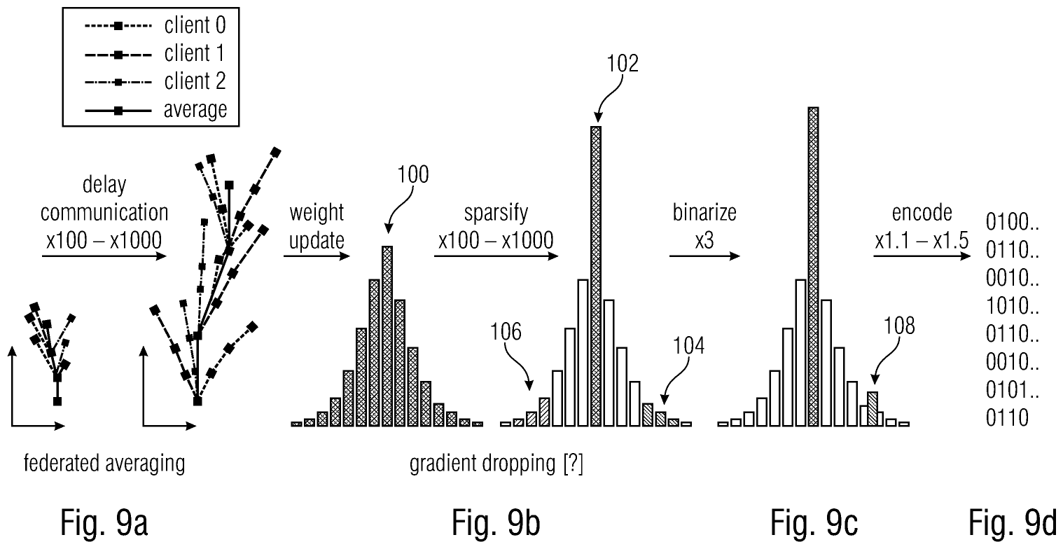

As described later on, any average value indicative of a central tendency of the coded set {j=(1−p)card(W) . . . card(W)|sort(W)ⱼ} may be used with the mean value forming merely on example. For instance, the median or mode could be used instead.
Sparse Binary Compression To further reduce the communication cost of Deep Gradient Compression AND Smart Gradient Compression, we may set all but the fraction p biggest and fraction p smallest weight-updates to zero. Next, we compute the mean of all remaining positive and all remaining negative weight-updates independently. If the positive mean is bigger than the absolute negative mean, we set all negative values to zero and all positive values to the positive mean and vice versa. Again, the mean value is merely one example for a measure of average and the other examples mentioned with respect to SGC could be used as well. For better understanding, the method is illustrated in FIG. 9. Quantizing the non-zero elements of the sparsified weight-update reduces the used value bits from 32 to 0. This translates to a reduction in communication cost by a factor of around ×3.

To communicate a set of sparse binary weight-updates produced by SBC, we only need to transfer the positions of the non-zero elements, along with either the respective positive or negative mean. Instead of communicating the absolute non-zero positions, it is favorable to only communicate the distances between them. Under the assumption that the sparsity pattern is random for every weight-update, it is easy to show that these distances are geometrically distributed with success probability p equal to the sparsity rate. Geometrically distributed sequences can be optimally encoded using the Golomb code (this last lossless compression step can be also applied in the Deep Gradient Compression and Smart Gradient Compression scheme.

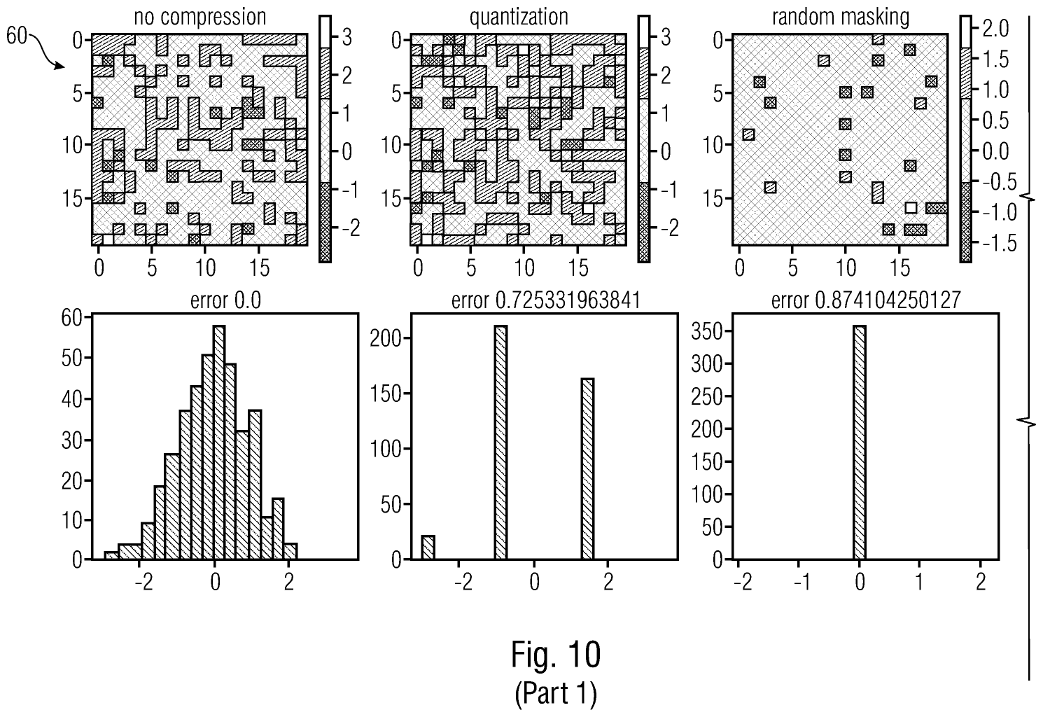

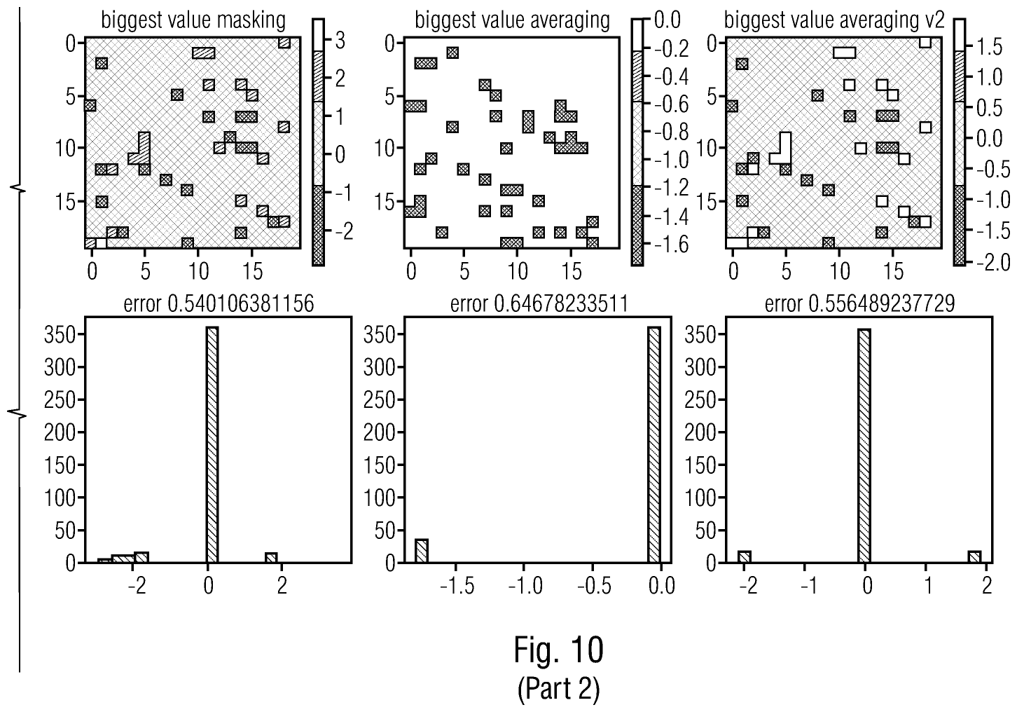

The different coding lossy schemes are summarized in FIG. 10. FIG. 10 shows different lossy coding concepts. From left to right, FIG. 10 illustrates no compression at the left hand side followed by five different concepts of quantization and sparsification. At the upper line of FIG. 10, the actually coded version is shown, i.e., 66. Below, FIG. 10 shows the histogram of the coded values 82 and the coded version 66. The mean arrow is indicated above the respective histogram. The right hand side sparsification concept corresponds to smart gradient compression while the second from the right corresponds to sparse binary compression.

As can be seen, the sparse binary compression causes a slightly larger coding loss or coding error than compared to smart gradient compression, but on the other hand, the transmission overhead is reduced, too, owing to the fact that all transmitted coded values 82 are of the same sign or, differently speaking, correspond to the also transmitted mean value in both magnitude and sign. Again, instead of using the mean, another average measure could be used. Let's go back to FIGS. 9a to 9d. FIG. 9a illustrates the traversal of the parameter space determined by the parameterization 18 with regular DSGD at the left hand side and using federated averaging at the right hand side. With this form of communication delay, a bigger region of the loss-surface can be traversed in the same number of communication rounds. That way, compression gains of up to ×1000 are possible. After a number of iterations, the clients communicate their locally computed weight updates or parameterization updates. Before communication, the parameterization update is sparsified. To this end, all update values 80 but the fraction p parameterization update values 80 with highest magnitude are dropped. That is, they are excluded from the lossy coding. FIG. 9b shows at 100 the histogram of parameterization update values 80 to be transmitted. At 102, FIG. 9b shows the histogram of these values with setting all non-coded or excluded values to zero. A first set of highest or largest update values is indicated at 104 and a second set 106 of lowest or smallest update values is indicate at 106. This sparsification already achieves up to ×1000 compression gain. Sparse binary compression does, however, not stop here. As shown at c, in FIG. 9, the sparse parameterization update is binarized for an additional compression gain of approximately ×3. This is done, by selecting among sets 104 and 106 the one the mean value of which is higher in magnitude. In the example of FIG. 9c, this is set 104 with the mean value of which being indicated at 108. This mean value 108 is then actually coded along with the identification information which indicates or identifies set 104, i.e., the set of parameters 26 of parameterization 18 for which the mean value 108 is then transmitted to indicate the coded parameterization update value 82. FIG. 9d illustrates that an additional coding gain may, for instance, be obtained by applying, for instance, Golomb encoding. Here, the bit-size of the compressed parameterization update may be reduced by another ×1.1-×1.5 compared to transmitting the identification information plus the mean value 108 naively.

The choice of the encoding plays a crucial role in determining the final bit-size of a compressed weight-update. Ideally, we would like to design lossless codec schemes which come as close as possible to the theoretical minimum.

To recall, we will shortly derive the minimal bit-length that is needed in order to lossless encode an entire array of gradient values. For this, we assume that each element of the gradient matrix is an output from a random vector ΔW∈ [symbol] ^{N}, where N is the total number of elements in the gradient matrix (that is, N=mn where m is the number of rows and n the number of columns). We further assume that each element is sampled from an independent random variable (thus, no correlations between the elements are assumed). The corresponding joint probability distribution is then given by

P(ΔW₁=g₁, . . . ,ΔW_{N}=g_{N})=Πᵢ^{N}P(ΔWᵢ=gᵢ) (23)

where gᵢ∈ [symbol] are concrete sample values from the ΔWᵢ random variables, which belong to the random vector ΔW.

It is well known [13] that if suitable lossless codecs are used, the minimal average bit-length needed to send such a vector is bounded by

NH(ΔWᵢ)<l̅ₘᵢₙ(ΔW)<NH(ΔWᵢ)+1 for all i (24)

where

H(X)=−ΣⱼP(xⱼ)log₂(P(xⱼ)) (25)

denotes the entropy a random variable X.

Uniform Quantization

If we use uniform quantization with K=2^{b} grid points and assume a uniform distribution over these points, we have P(ΔWᵢ=gᵢ)=1/K and consequently

H(ΔWᵢ)=−Σⱼ^{K} log₂K=b (26)

That is, b is the minimum number of bits that are sent per element of the gradient vector G.

Deep Gradient Compression

In the DGC training procedure only a certain percentage p∈(0,1) of gradient elements are set to 0 and the rest are exchanged in the communication phase. Hence, the probability that a particular number is send/received is given by

$$P ( Δ {W}_{i} = {g}_{i} ) = \{ \begin{matrix}( 1 - p ) \frac{1}{K} & for {g}_{i} \neq 0 \\ p & for {g}_{i} = 0\end{matrix}$$

were we uniformly quantize the non zero values with K=2^{b} bins. The respective entropy is then

H(ΔWᵢ)=−p log₂(p)−(1−p)log₂(1−p)+b(1−p) (27)

In other words, the minimum average bit-length is determined by the minimum bit-length used to identify if an element is either a zero or non-zero element (the first two sumands), plus the bits used to send the actual value whenever the element was identified as a non zero value (the last summand).

Smart Gradient Compression

In our framework we further reduce the entropy by reducing the number of non zero weight values to one. That is, K=2⁰. Hence, we only have to send the position of the non zero element. Therefore our theoretical bound is lower than (27) and given by

H(ΔWᵢ)=−p log₂(p)−(1−p)log₂(1−p) (28)

In practice, we the receiver doesn't know the value so we would have to sind it too, which induces an additional, often negligible cost of b-bits.

We just described how we can model the gradient values of the neural network as being a particular outcome of an N-long independent random process. In addition, we also described the models of the probability distributions when different quantization methods are used in the communication phase of the training. Now it remains to design low redundant lossless codecs (low redundant in the sense, that their average bit-length per element is close to the theoretical lower bound (24)). Efficient codecs for these cases have been well studied in the literature [13]. In particular, binary arithmetic coding techniques have shown to be particularly efficient and are widely used in the fields of image and video coding. Hence, once we selected a probability model, we may code the gradient values using these techniques.

We can further reduce the cost of sending/receiving the gradient matrix ΔW by making use of predictive coding methods. To recall, in the sparse communication setting we specify a percentage of gradients with highest absolute values and send only those (at both, the server and client side). Then, the gradients that have been send are set back to 0 and the others are accumulated locally. This means that we can make some estimates regarding the probability that a particular element is going to be send at the next iteration (or next iterations τ), and consequently reduce the communication cost.

Let ρᵢ(g|μᵢ(t),σᵢ(t),t) be the probability density function of the absolute value of the gradients of the i-th element at time t, where μᵢ(t) and σᵢ(t) are the mean and variance of the distribution. Then, the probability that the i-th element will be updated is given by the cumulative probability distribution

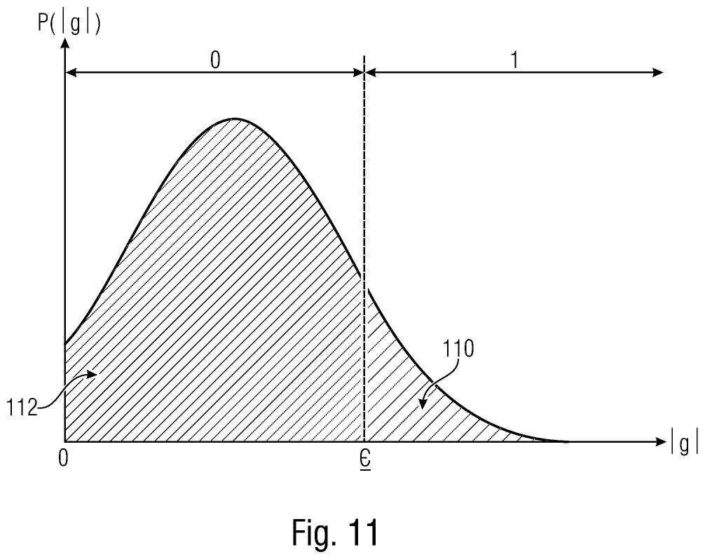

P(i=1|t)=∫_{ε}^{∞}ρᵢ(g|μᵢ(t),σᵢ(t),t)dg (29)

where ε is selected such, that P(i=1|t)>0.5 for a particular percentage of elements. A sketch of this model is depicted in FIG. 11.

FIG. 11 shows a sketch of the probability distribution of the absolute value of the gradients. The area 110 indicates the probability of the gradient being updated at the current communication round (and analogously the area 112 indicates the contrary probability). Since we accumulate the gradient values over time for those elements which have not been updated, the variance (and mean if it's not 0) of the distribution increases over time. As such, the blue area increases over time too, effectively increasing the probability of the element being updated in the next communication round.

Now we can easily imagine that different elements have different gradient probability distributions (even if we assume that all have the same type, they might have different means and variances), leading to them having different update rates. This is actually supported by experimental evidence, as can be seen in FIG. 11, where a diagram is depicted that shows the distribution of elements with different update rates.

Hence, a more suitable probability model of the update frequency of the gradients would be to assign a particular probability rate pᵢ to each element (or to a group of elements). We could estimate the element specific update rates pᵢ by keeping track of the update frequency over a period of time and calculate it according to these observations.

However, the above simple model makes the naive assumption that the probability density functions don't change over time. We know that this is not true for two reasons. One, the mean of the gradients tends to 0 as training time grows (and experiments have shown that with the SGD optimizer the variances grow over time). And two, as mentioned before, we accumulate the gradient values of those elements that have not been updated. Thus, we get an increasing sum over random variables over time. Hence, the probability density function at time t*+τ (where τ is the time after the last update t) corresponds to the convolution over all probability density functions between the time t*→t*+τ. If we further assume that the random variables are independent along the time achsis, we then know that the mean and variance of the resulting probability density function corresponds to the sum of their mean and variances

[symbol]

[ρᵢ(g|t*+τ)]=Σ_{t*}^{τ}μ(t)

var[ρᵢ(g|t*+τ)]Σ_{t*}^{τ}σ(t)

Consequently, as long as one of those sums don't converge as τ→∞, it is guaranteed that the probability of an element being updated in the next iteration round tends to 1 (that is, P(i=1|t*+τ)→1 as τ→∞).

However, modeling the real time-dependent update rate can be too complex. Therefore we may model it via simpler distributions. For example, we might assume that the probability of encountering τ consecutive zeros follows the geometric distribution (1−pᵢ)^{τ}, where pᵢ indicates the update rate of element i in the stationary mode. But other models where the probability increases overtime might as well be assumed (e.g. P(i=1|τ, aᵢ,bᵢ)=1−aᵢe^{b}^{ᵢ}^{τ} or any model belonging to the exponential family with adjustable parameters).

Furthermore, we can use adaptive coding techniques in order to estimate the probability parameters in an online fashion. That is, we use the information about the updates at each communication round in order to fine tune the parameters of the assumed probability. For example, if we model the update rate of the gradients as a stationary (not time dependent) Bernoulli distribution P(i=1)=pᵢ, then the values pᵢ can be learned in an online fashion by taking the sample mean (that is, if xₜ∈{0,1} is a particular outcome at time (or cycle) t, then p_{i,t+1}=(xₜ+p_{i,t})/t).

The advantage of this methods is that the parameter estimation occurs at the sender and receiver side simultaneously, resulting in no communication overhead. However, this comes at the cost of increasing the complexity of the encoder and decoder (for more complex models the online parameter update rule can be fairly complex). Therefore, an optimal trade-off between model complexity and communication cost has to be considered depending on the situation.

E.g., in the distributed setting where communication rounds are high and communication latency ought to be minimal, simple models like the static rate frequency model pᵢ or geometric distribution (1−pᵢ)^{τ} for predictive coding might be a good choice (perhaps any of the distribution belonging to the exponential family distributions, since online update rules for their parameters are simple and well known for those models). On the other hand, we may be able to increase the complexity of the model (and with it the compression gains) in the federated learning scenario, since it is assumed that the computational resource are high in comparison to the communication costs.

The above idea can be generalized to non smart gradient matrices G∈ [symbol] ^{m×n}. Again, we think of each element Gᵢ˜gᵢ, i∈{1, . . . , N(=m×n)), of the matrix G as a random variable that outputs real valued gradients gᵢ. In our case, we are only interested in matrices whose elements can only output values from a finite set gᵢ∈ [symbol] :=ω₀=0, ω₁, . . . , ω_{S-1}}. Each element ωₖ of the set [symbol] has a probability mass value pₖ∈ [symbol] :={p₀, . . . , p_{S-1}} assigned to it. We encounter this cases when we use other forms of quantizations for the gradients, such as uniform quantization schemes.

We further assume that the sender and receiver share the same sets [symbol] . They either agreed before training started on the set of values [symbol] or a new tables might be send during training (the later should only applied if the cost of updating the set [symbol] is negligible comparing to the cost of sending the gradients). Each element of the matrix might have an independent set [symbol] ᵢ or a group (or all) of elements might share the same set values.

As for the probabilities [symbol] (that is, the probability mass function of the set [symbol] , which depends on element i), we can analogously model them and apply adaptive coding techniques in order to update the model parameters in accordance to the gradient data send/received during training. For example, we might model a stationary (not time dependent) probability mass distribution [symbol] ={p₀ⁱ, . . . , p_{S-1}ⁱ} for each ith-element in the network, where we update the values pₖⁱ according to their frequency of appearance during training. Naturally, the resulting codec will then depend on the value [symbol] .

Furthermore, we might as well model a time dependence of the probabilities pₖⁱ(t). Let ƒₖⁱ(t)∈(0,1) be a monotonic decreasing function. Also, let t_{k,i}* be the time step indicating that the i-th gradient has changed it's value to ωₖ and τ the time after that point. Then, we can write

pₖⁱ(t_{k,i}*+τ)=ƒₖⁱ(τ)

$${p}_{{k}^{′}}^{i} ( {t}_{k , i}^{*} + τ ) = \frac{1 - {f}_{k}^{i} ( τ )}{{\sum }_{{k}^{″} \neq k}^{S - 1} {p}_{{k}^{″}}^{i}} {p}_{{k}^{′}}^{i}$$

That is, the probability that the same value will be chosen at τ consecutive time steps decreases, consequently progressively increasing the probability of the other values over time.

Now we have to find suitable models for each function ƒₖⁱ(t), where we have to trade-off between codec complexity and compression gain. For example, we might as well model the retention time of each value k with a geometric distribution. That is, pₖⁱ(t_{k,i}*+τ)=(pₖⁱ)^{τ}, and take advantage of adaptive coding techniques in order to estimate the parameters pₖⁱ during training.

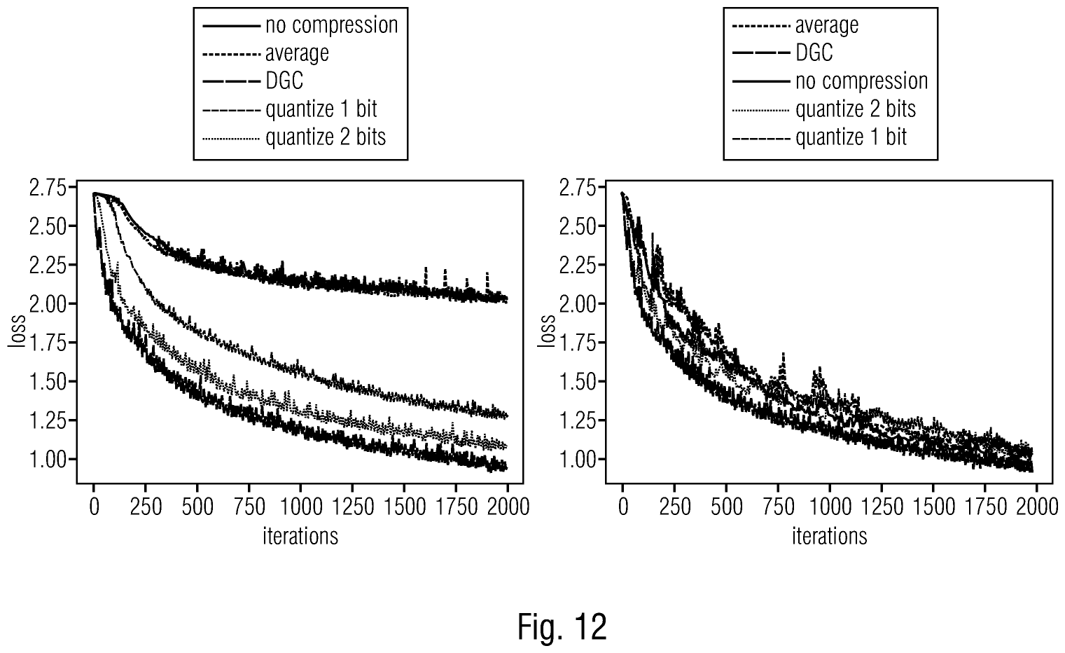

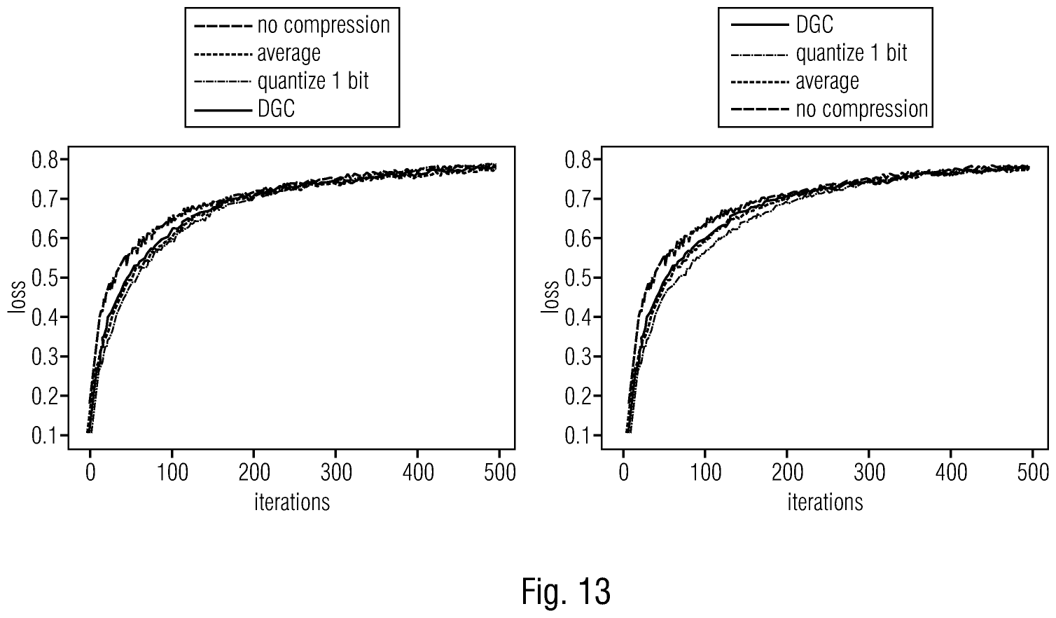

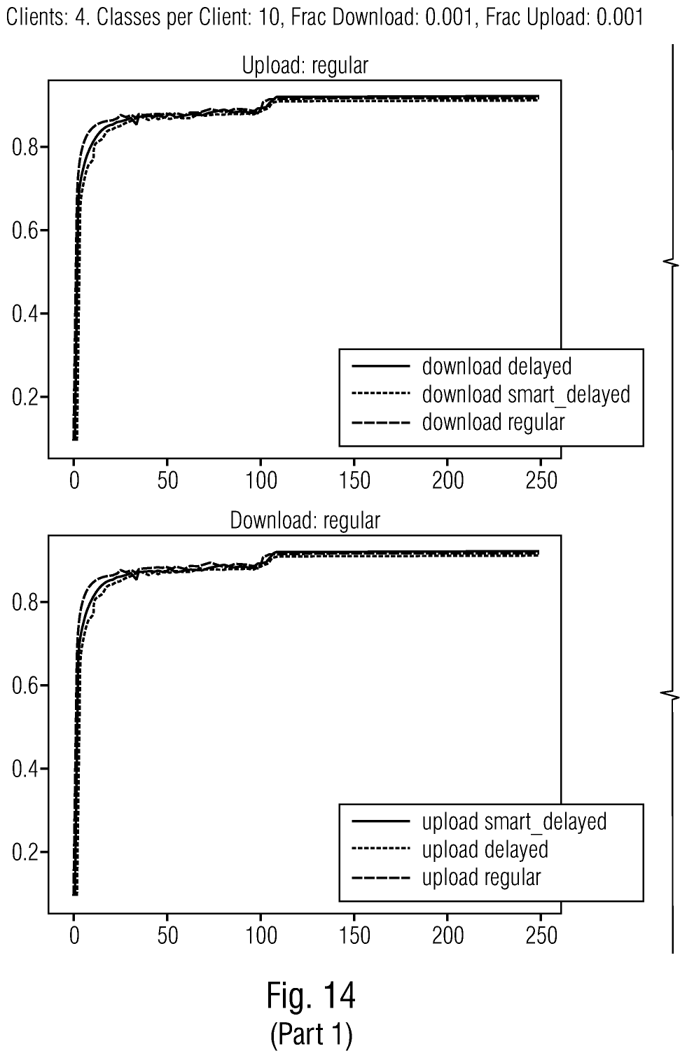

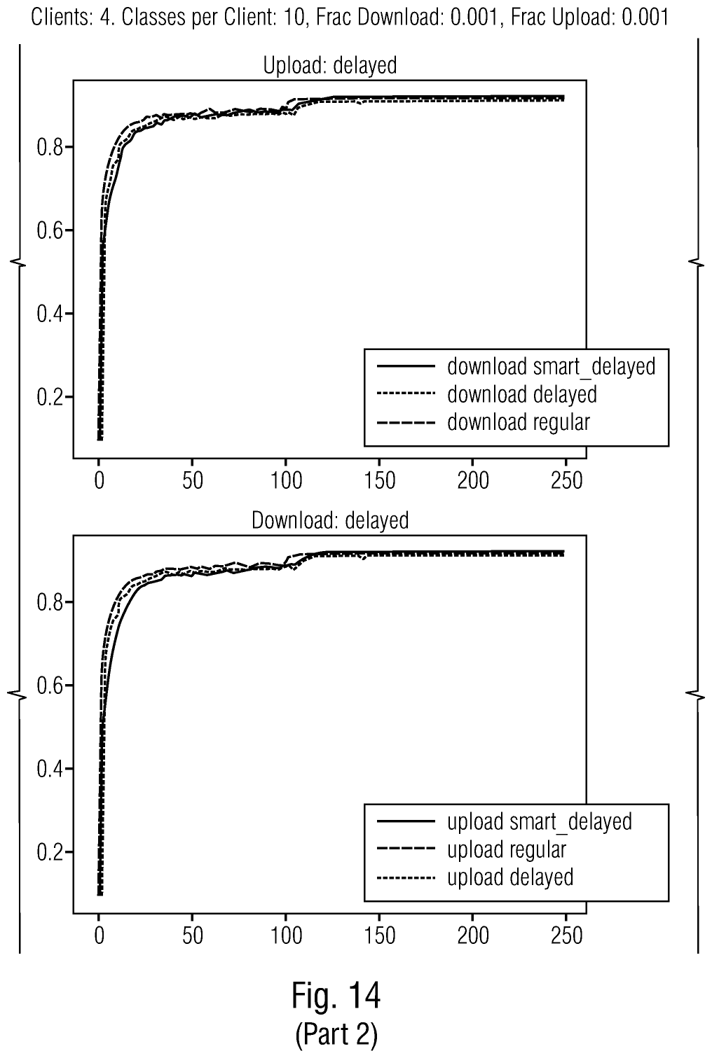

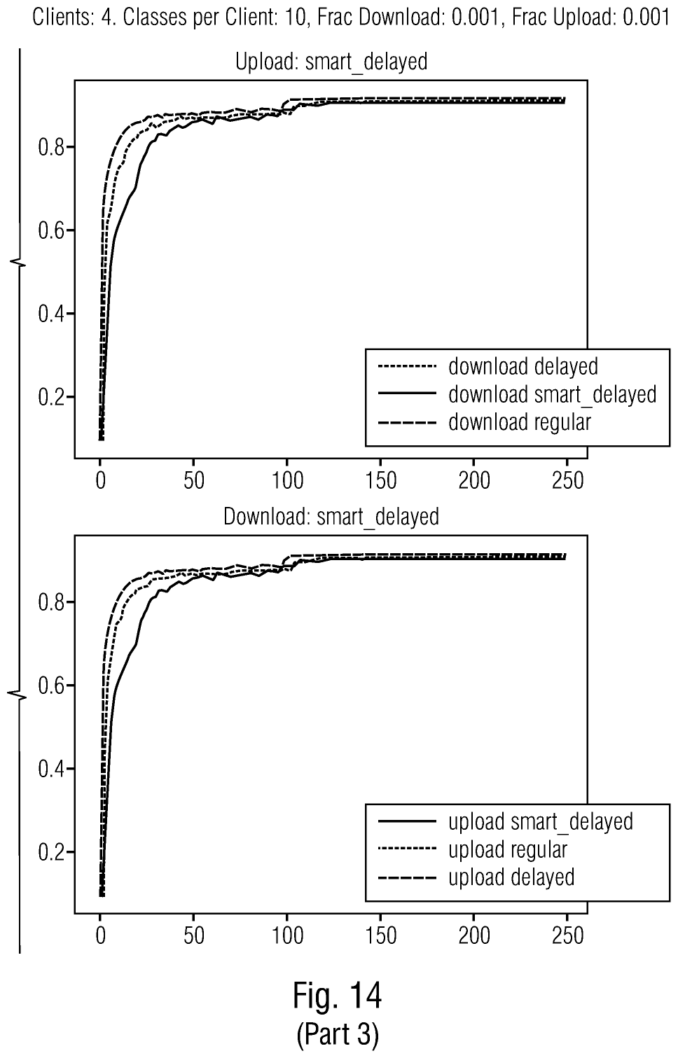

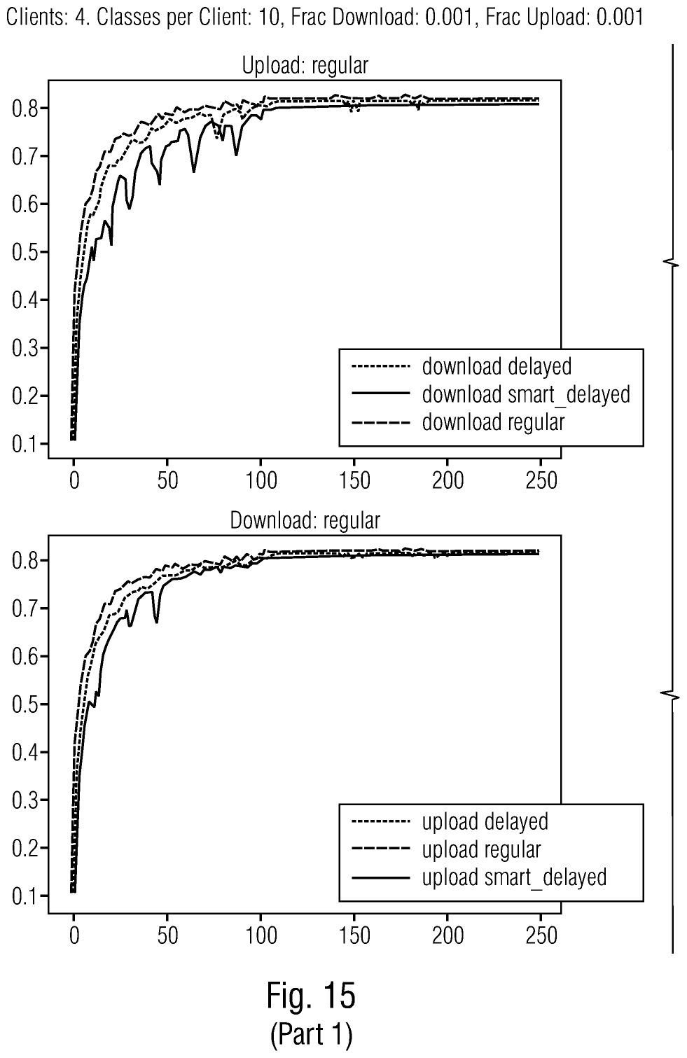

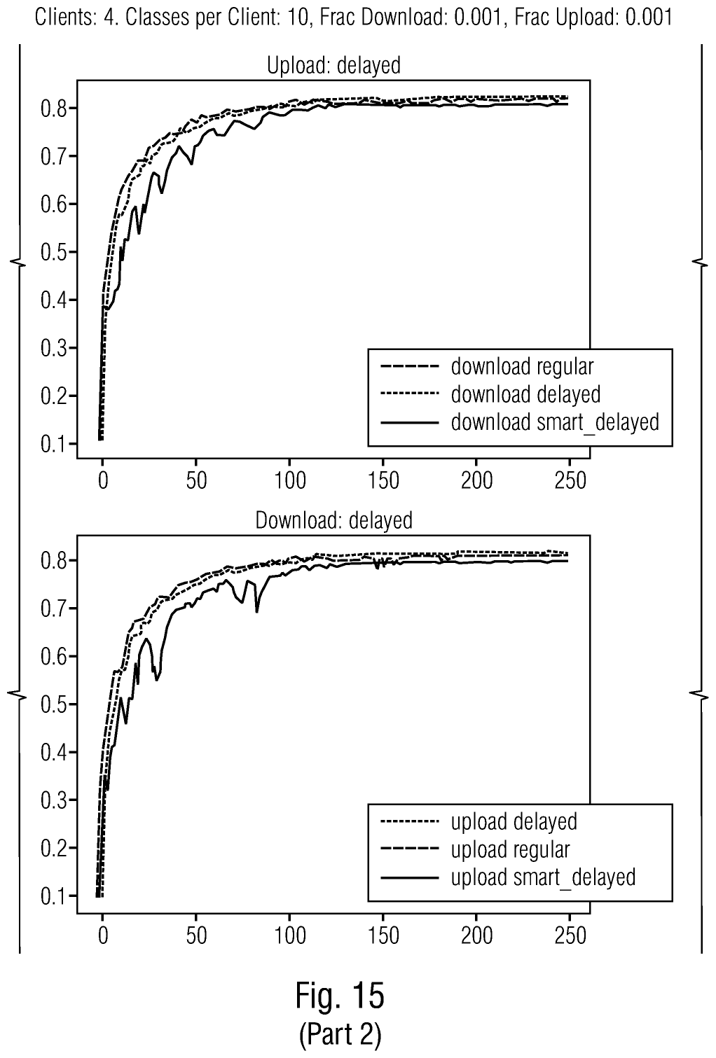

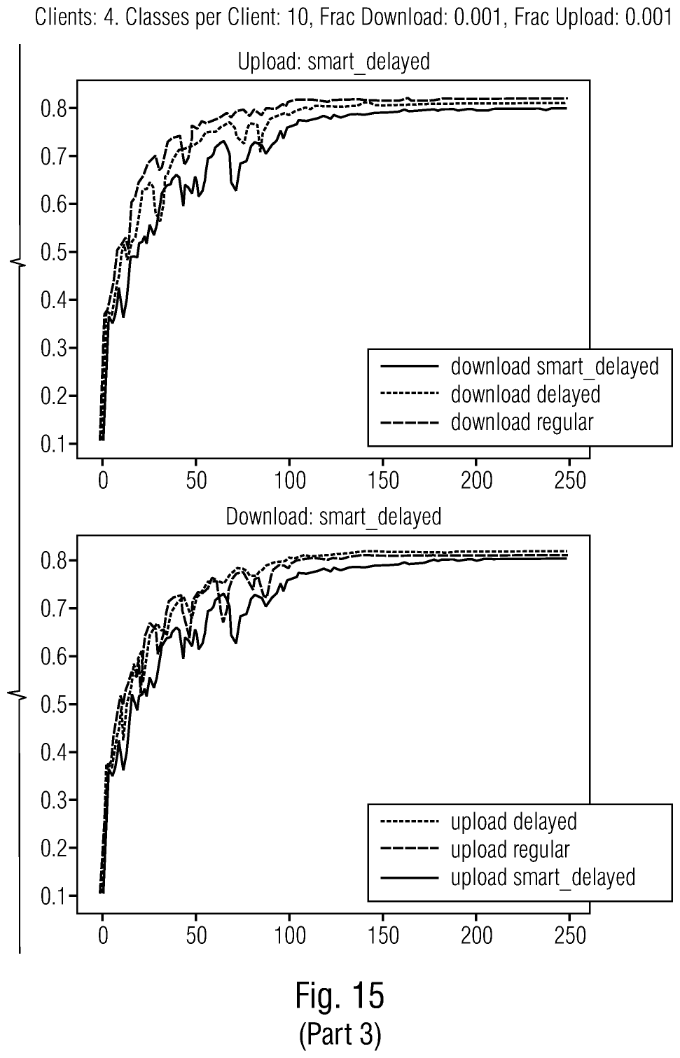

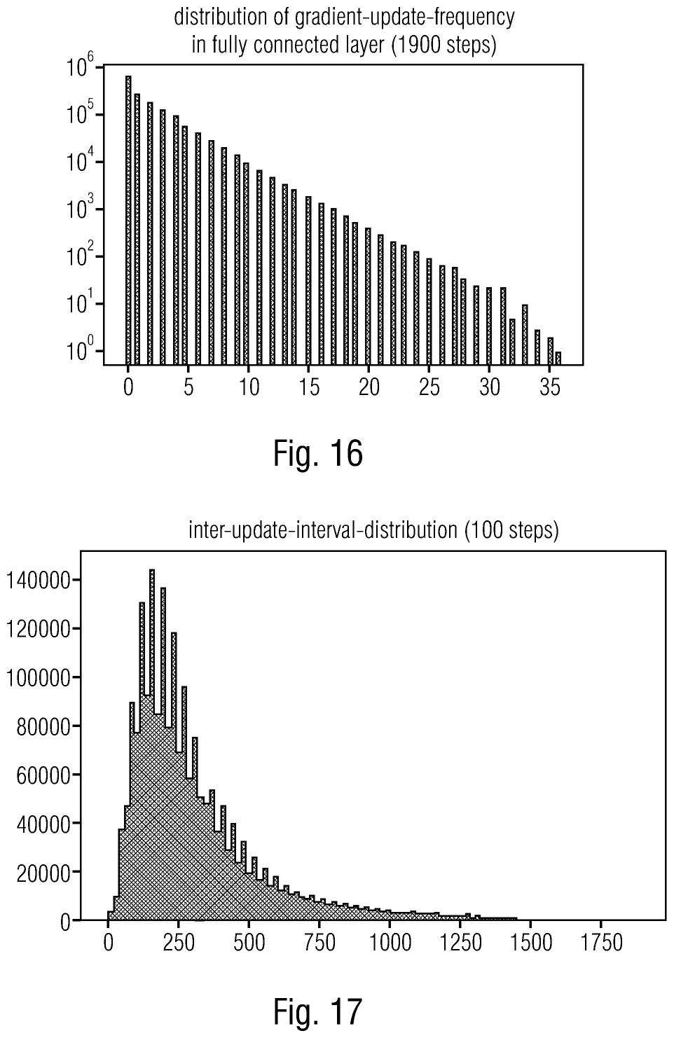

Experimental results are depicted in FIGS. 12 to 17. FIG. 12 shows the effect of local accumulation on the convergence speed. Left: No local accumulation, Right: With local accumulation. FIG. 13 shows the effect of different compression methods on the convergence speed in federated learning. Model: CifarNet, Data-Set: CIFAR, Number Clients: 4, Data: iid, Iterations per Client: 4. FIG. 14 shows the effect of different sparsification methods in data-parallel learning. Model: ResNet, Data-Set: CIFAR, Number Clients 4, Data: iid, Iterations per Client: 1. FIG. 15 shows the effect of different sparsification methods in data-parallel learning. Model: ResNet, Data-Set: CIFAR, Number Clients 4, Data: iid, Iterations per Client: 1. FIG. 16 shows the distribution of gradient-update-frequency in fully connected layer (1900 steps). FIG. 17 shows an inter-update-interval-distribution (100 steps).

Now, after having described certain embodiments with respect to the preceding figures, some broadening embodiments shall be described. For example, in accordance with an embodiment, federated learning of a neural network 16 is done using the coding loss aware upload of the clients' parameterization updates. The general procedure might be as depicted in FIG. 6 with using the concept of coding loss aware upload as shown in FIG. 7 with respect to the upload 36 and as described with respect to FIG. 8. The inventors have found that coding loss aware parameterization update upload is not only advantageous in case of data-parallel learning scenarios where the training data is evenly split across the supporting clients 14. Rather, it appears that a coding loss accumulation and inclusion of this accumulation in the updates allows for rendering more efficient the lossy coding of the parameterization update uploads in case of federated learning where the individual clients tend to spend more effort on individually training the neural network on the respective individual (at least partially gather individually as explained above with respect to FIG. 3) training data before the individual parameterization updates thus uploaded are subject to merging and re-distributed via the download. Thus, according to this broadening embodiment, the coding loss aware transmission of the parameterization updates during the upload in FIG. 7 may be used without the usage of coding loss awareness in connection with the download of the merged parameterization update as described previously with respect to FIG. 7. Further, it is recalled what has been noted above with respect to FIG. 3: Synchrony of the client-server communication and inter actions between the various clients is not required, and while the general mode of operation between client and server applies for all client-server pairs, i.e. for all clients, the cycles and the exchanged update information may be different.

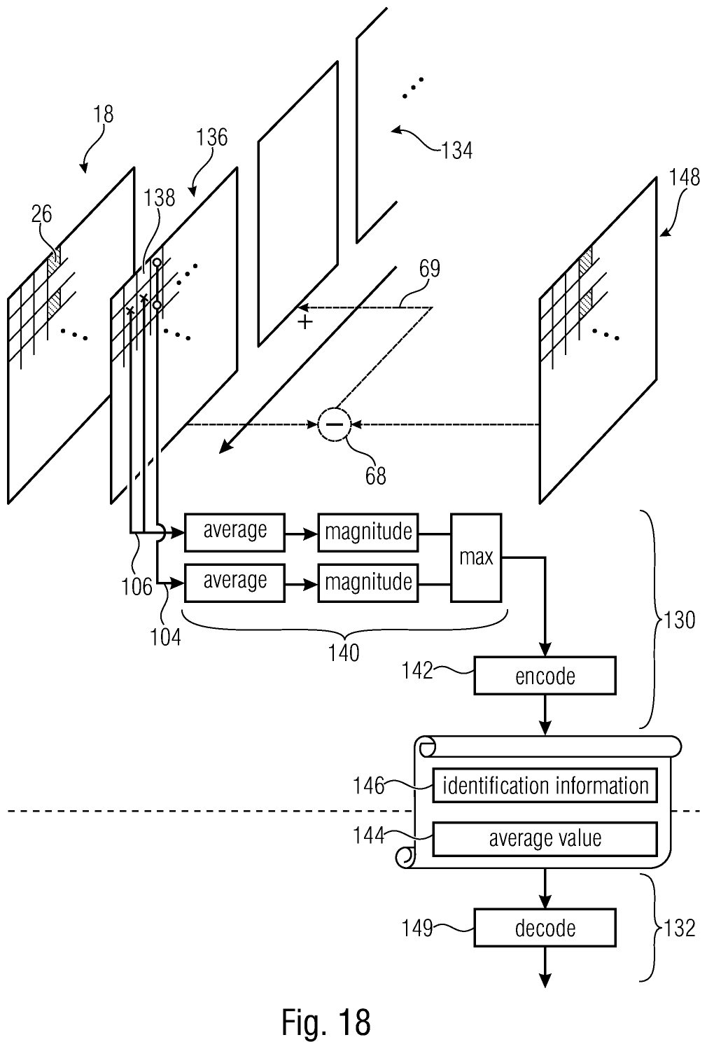

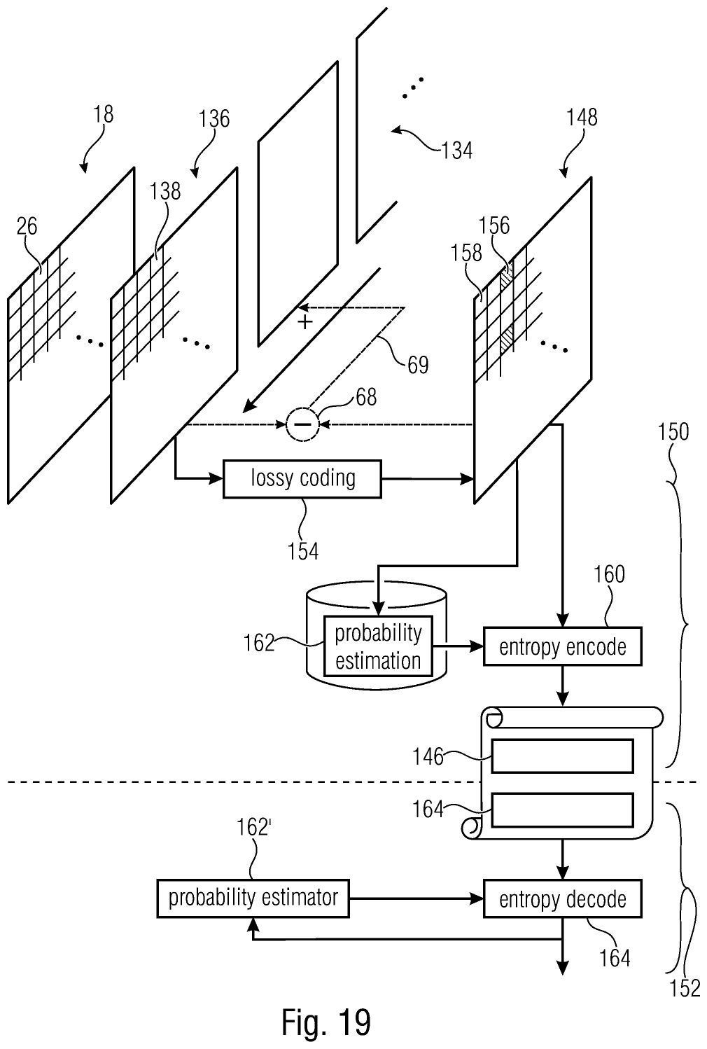

Another embodiment results from the above description in the following manner. Although the above description primarily concerned federated learning, irrespective of the exact type of distributed learning, advantages may be achieved by applying the coding loss aware parameterization update transmission 56 and the downlink step 32. Here, the coding loss accumulation and awareness is performed on the side of the server rather than the client. It should be noted that the achievable reduction in amount of downloaded parameterization update information is considerable by applying the coding loss awareness as offered by procedure 56 into the download direction of a distributed learning scenario, whereas the convergence speed is substantially maintained. Thus, while in FIG. 7 the coding loss awareness is applied on both sides, upload and download of the parameterization updates, a possible modification resulting into the just-presented embodiment is achieved by leaving off, for instance, the coding loss awareness at the side of the uplink procedure. When using the coding loss awareness on both sides, i.e., by performing procedure 56 on the client side with respect to the uplink and on the server side with respect to the downlink, this enables to design the overall learning scenario in a manner so that the occurrence of coding losses are carefully distributed over server on the one hand and clients on the other hand. Again, reference is made to the above note regarding the non-requirement of synchrony between the clients as far as the client-server interaction is concerned. This note shall also apply to the following description of embodiments with respect to FIGS. 18 and 19.

Another embodiment which may be derived from the above-description by taking advantage of the advantageous nature of the respective concept independent from the other details set out in the above embodiments pertains to the way the lossy coding of consecutive parameterization updates may be performed with respect to a quantization and sparsification of the lossy coding. In FIG. 7, the quantization and sparsification occur in the compression steps 64 with respect to upload and download. As described above, sparse binary compression may be used herein. In alternative embodiments, modified embodiments may be obtained from FIG. 7, by using sparse binary compression as described again with respect to FIG. 18, merely in connection with upload or in connection with download or both. Moreover, the embodiment described with respect to FIG. 18 not necessarily uses sparse binary compression along or in combination with coding loss aware transmission 56. Rather, the consecutive parameterization updates may be lossy coded in a non-accumulated coding-loss unaware manner.

FIG. 18 illustrates the lossy coding of consecutive parameterization updates of a parameterization 18 of a neural network 16 for distributed learning and, in particular, the module used at the encoder side or sender side, namely 130 and the one used at the receiver or decoder side 132. In the implementation of FIG. 7, for instance, module 130 may be built in to the clients for using the signed binary compression in the upload direction while module 132 may then be implemented in the server, and modules 132 and 130 may also be vice versa implemented in the clients and server for usage of the signed binary compression in the download direction.

Module 130, thus, forms and an apparatus for lossy coding consecutive parameterization updates. The sequence of parameterization updates is illustrated in FIG. 18 at 134. The currently loss encoded parameterization update is indicated at 136. Same may correspond to an accumulated parameterization update as indicated by 62 in FIG. 8, or a newly obtained parameterization update as indicated 50 in FIG. 8 when using no coding loss awareness. The sequence of parameterization updates 134 results from the cyclic nature of the distributed learning: each cycle, a new parameterization update 136 results. Each parameterization update such as the current parameterization update 136, comprises an update value 138 per parameter 26 of the parameterization 18.

Apparatus 130 starts its operation by determining a first set of update values and a second set of update values namely set 104 and 106. The first set 104 may be a set of highest update values 138 and the current parameterization update 136 while set 106 may be a set of lowest update values. In other words, when the update values 138 are ordered along their value, set 104 may form the continuous run of highest values 138 and the resulting order sequence, while set 106 may form a continuous run at the opposite end of the sequence of values, namely the lowest update values 138. The determination may be done in a manner so that both sets coincide in cardinality, i.e., they have the same number of update values 138 therein. The predetermined number of cardinality may be fixed or set by default, or may be determined by module 130 in a manner and on basis of information also available to the decoder 132. For instance, the number may explicitly be transmitted. A selection 140 is performed among sets 104 and 106 by averaging, separately, the update values 138 in both sets 104 and 106 and comparing the magnitude of both averages with finally selecting the set the absolute average of which is larger. As indicated above, the mean such as the arithmetic mean or some other mean value may be used as average measure, or some other measure such as mode or median. In particular, then, module 130 codes 142, as information on the current parameterization update 136, the average value 144 of the selected larger set, along with an identification information 146 which identifies, or locates, the coded set of parameters 26 of the parameterization 18, the corresponding update value 138 in the current parameterization update 136 of which is included in the selected largest set. FIG. 18 illustrates, for instance, at 148, that for the current parameterization update 136, set 104 is chosen as the largest set of update values, with the set being indicated using hatching. The corresponding coded set of parameters is illustratively shown in FIG. 18 also as being hatched. The identification information 146, thus, locates or indicates where parameters 26 are located for which an update value 138 is coded represented as being equal to the average value 144 both in magnitude and sign.

As already described above, it is merely a minor impact on convergence speed, that per parameterization update of the sequence 134, merely one of sets 104 and 106 is actually coded, while the other is left uncoded, because along the sequence of cycles, the selection toggles, depending on the training outcomes in the consecutive cycles—between the set 104 of highest update values and the set 106 of lowest update values. On the other hand, signaling overhead for the transmission is reduced owing to the fact that it is not necessary to code information on the signed relationship between each coded update value and the average value 144.

The decoder 132 decodes the identification information 146 and the average value 144 and sets the largest set of update values indicated by the identification information 146, i.e., the largest set, to be equal in sign and magnitude to the average value 144, while the other update values are set to be a predetermined value such as zero.

As illustrated in FIG. 18 by dashed lines, when using the quantization and sparsity procedure of FIG. 18 along with coding loss awareness, the sequence of parameterization updates may be a sequence 134 of accumulated parameterization updates in that the coding loss determined by subtraction 68 is buffered to be taken into account, namely to at least partially contribute to, such as by weighted addition, to the succeeding parameterization update. The apparatus for decoding the consecutive parameterization updates 132 behaves the same. Merely the convergence speed increases.

A modification of the embodiment of FIG. 18, which operates according to SGC discussed above, is achieved of the coded set of updates values is chosen to comprise the largest—in terms of magnitude—update values with accompanying the information on the current parametrization update with sign information which, individually for each update value in the coded set of update values associated with the coded set of parameters indicated by the identification information 146, indicates the signed relationship between the average value and the respective update value, namely whether same is represented to equal the average in magnitude and sign or is the additive inverse thereof. The sign information may indicate the sign relationship between the members of the coded set of update values and the average value not necessarily using a flag or sign bit per coded update value. Rather, it may suffice to signal or otherwise subdivide the identification information 146 in a manner so that comprises two subsets: one indicating the parameters 26 for which the corresponding update value is minus the average value (quasi belong to set 106) and one indicating the parameters 26 for which the corresponding update value is exactly (including sign) the average value (quasi belong to set 104). Experiments revealed that usage of one average measure as the only representative of the magnitude of the coded (positive and negative) largest update values nevertheless leads to a pretty good convergence speed as a reasonable communication overhead associated with the update transmissions (upload and/or download).

FIG. 19 relates to a further embodiment of the present application relating to a further aspect of the present application. It is obtained from the above description by picking-out the advantageous way of using entropy coding a lossy coded representation of consecutive parameterization updates. FIG. 19 shows a coding module 150 and a decoding module 152. Module 150 may, thus, be used on the sender side of consecutive parametrization updates such as implemented in the clients as far as the parameterization update upload 36 is concerned, and in this server as far as the merged parameterization update download is concerned, and module 150 may be implemented in the receiver side, namely in the clients as far as the parameterization update download is concerned, and in the server as far as the upload is concerned. The encoder module 150 may, in particular, represent the encoding module 142 in FIG. 18 and the decoding module 152 may form the decoding module 149 of the apparatus 132 of FIG. 18 meaning that the entropy coding concept which FIG. 19 relates to may, optionally, be combined with the advantageous sparsification concept of FIG. 18, namely SBC, or the one described as a modification thereof, namely SGC. This is, however, not necessary.

In the description of FIG. 19, the reference signs already introduced above are reused in order to focus the following description onto the differences and details specific for the embodiment of FIG. 19.

Thus, apparatus 150 represents an apparatus for coding consecutive parametrization updates 134 of a neural network's 16 parameterization 18 for distributed learning and is configured, to this end, to lossy code the consecutive parameterization updates using entropy coding using probability distribution estimates. To be more precise, the apparatus 150 firstly subjects the current parameterization update 136 to a lossy coding 154 which may be, but is not necessarily implemented as described with respect to FIG. 18. The result of the lossy coding 144, is the fact that the update values 138 of the current parameterization update 136 are classified into ones coded indicated using reference sign 156 in FIG. 19 and being illustrated using hatching as done in FIG. 18, (same, thus, form the coded set of update values) and ones non-coded, namely 158 and being non-hatched in FIG. 19. For example, when using SBC as done in FIG. 18, set 156 would be 104 or 106. The non-coded update values 158 of the actually coded version 148 of the current parameterization update 136 are deemed, for instance, and as already outlined above, as being set to a predetermined value such as zero, while some sort of quantization value or quantization values are assigned by the lossy coding 154 to the coded values 156 such as one common average value of uniform sign and magnitude in case of FIG. 18 although alternative concepts are feasible as well. An entropy encoding module 160 of encoding module 150 then losslessly codes version 148 using entropy coding and using probability distribution estimates which are determined by a probability estimation module 162. The latter module performs the probability estimation for the entropy coding with respect to a current parameterization update 136 by evaluating the lossy coding of previous parameterization updates in sequence 134 the information on which is also available to the corresponding probability estimation module 162′ at the receiver/decoder side. For instance, the probability estimation module 162 logs for each parameter 26 of parameterization 18, the membership of the corresponding coded value in the coded version 148 to the coded values 156 or the non-coded values 148, i.e., whether an update value is contained in the coded version 148 for the respective parameter 26 in a corresponding preceding cycle or not. Based thereon the probability estimation module 162 determines, for instance, a probability p(i) per parameter i of parameterization 18, that an update value ΔWₖ(i) for parameter i is comprised by the coded set of update values 156 or not (i.e. belongs to set 158) for the current cycle k. In other words, module 162 determines, for example, probability p(i) based on the membership of the update value ΔWₖ(i) for parameter i for cycle k−1 to the coded set 156 or the non-coded set 158. This may be done by updating the probability for that parameter i as determined for the previous cycle, i.e. by continuously updating, at each cycle, p(i) depending on the membership of the update value ΔWₖ(i) for parameter i for cycle k−1 to the coded set 156 or the non-coded set 158, i.e., whether an update value is contained in the coded version 148 for the respective parameter 26 in the corresponding preceding cycle k−1 or not. The entropy encoder 160 may, in particular, encode the coded version 148 in form of identification information 146 identifying the coded update values 156, i.e., indicating to which parameters 26 they belong, as well as information 164 for assigning the coded values (quantization levels) 156 to the thus identified parameters such as one common average value as in the case of FIG. 18. The probability distribution estimate determined by determiner 162 may, for instance, be used in coding the identification information 146. For instance, the identification information 146 may comprise one flag per parameter 26 of parameterization 18, indicating whether the corresponding coded update value of the coded version 148 of the current parameterization update 136 belongs to the coded set 156 or the non-coded set 158 with entropy coding this flag such as arithmetically coding this flag using a probability distribution estimation determined based on the evaluation of preceding coded versions 148 of preceding parameterization updates of sequence 134 such as by arithmetically coding the flag for parameter i using the afore-mentioned p(i) as probability estimate. Alternatively, the identification information 146 may identify the coded update values 156 using variable length codes of pointers into an ordered list of the parameters 26, namely ordered according to the probability distribution estimation derived by determiner 162, i.e. ordered according to p(i) for instance. The ordering could, for instance, order parameters 26 according to the probability that for the corresponding parameter a corresponding value in the coded version 148 belongs to the coded set 156, i.e. according to p(i). The VLC length would, accordingly, increase with increasing probability p(i) for the parameters i. As the probability is continuously adapted based on the membership of the various parameter's 26 update values belonging to the coded set of update values or not in preceding cycles, the probability estimate may likewise be determined at receiver/decoder side.

At the decoding side, the apparatus for decoding the consecutive parameterization updates does the reverse, i.e., it entropy decodes 164 the information 146 and 164 using probability estimates which a probability estimator 162′ determines from preceding coded versions 148 of preceding parameterization updates in exactly the same manner as the probability distribution estimator 162 at the encoder side did.

Thus, as noted above, the four aspects specifically described herein may be combined in pairs, triplets or all of them, thereby improving the efficiency in distributed learning in the manner outlined above.

Summarizing, above embodiments enable to achieve improvements in Distributed Deep Learning (DDL) which has gotten a lot of attention in the last couple of years as it is the core concept underlying both privacy-preserving deep learning and the latest successes in speeding up neural network training via increased data-parallelism. The relevance of DDL is very likely going to increase even further in the future as more and more distributed devices are expected to be able to train Deep Neural Networks, due to advances both in hardware and software. In almost all applications of DDL the communication-cost between the individual computation nodes is a limiting factor for the performance of the whole system. As a result of this, a lot of research has gone into trying to reduce the amount of communication used between the nodes via lossy compression schemes. The embodiments described herein may be used in such framework for DDL and may extend past approaches in a manner so as to improve the communication-efficiency in distributed training. Compression at both up- and download was involved and efficient encoding and decoding of the compressed data has been featured.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus. Some or all of the method steps may be executed by (or using) a hardware apparatus, like for example, a microprocessor, a programmable computer or an electronic circuit. In some embodiments, one or more of the most important method steps may be executed by such an apparatus.

The inventive codings of parametrization updates can be stored on a digital storage medium or can be transmitted on a transmission medium such as a wireless transmission medium or a wired transmission medium such as the Internet.

Depending on certain implementation requirements, embodiments of the invention can be implemented in hardware or in software. The implementation can be performed using a digital storage medium, for example a floppy disk, a DVD, a Blu-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. The data carrier, the digital storage medium or the recorded medium are typically tangible and/or non-transitionary.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

A further embodiment according to the invention comprises an apparatus or a system configured to transfer (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods may be performed by any hardware apparatus.

The apparatus described herein may be implemented using a hardware apparatus, or using a computer, or using a combination of a hardware apparatus and a computer.

The apparatus described herein, or any components of the apparatus described herein, may be implemented at least partially in hardware and/or in software.

The methods described herein may be performed using a hardware apparatus, or using a computer, or using a combination of a hardware apparatus and a computer.

The methods described herein, or any components of the apparatus described herein, may be performed at least partially by hardware and/or by software.

While this invention has been described in terms of several embodiments, there are alterations, permutations, and equivalents which will be apparent to others skilled in the art and which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

### REFERENCES

[1] Aiham Fikri Aji and Kenneth Heafield. Sparse communication for distributed gradient descent. arXiv preprint arXiv:1704.05021, 2017.
[2] Dan Alistarh, Demjan Grubic, Jerry Li, Ryota Tomioka, and Milan Vojnovic. Qsgd: Communication-efficient sgd via gradient quantization and encoding. In Advances in Neural Information Processing Systems, pages 1707-1718, 2017.
[3] Keith Bonawitz, Vladimir Ivanov, Ben Kreuter, Antonio Marcedone, H Brendan McMahan, Sarvar Patel, Daniel Ramage, Aaron Segal, and Karn Seth. Practical secure aggregation for privacy preserving machine learning. IACR Cryptology ePrint Archive, 2017:281, 2017.
[4] Jia Deng, Wei Dong, Richard Socher, Li-Jia Li, Kai Li, and Li Fei-Fei. Imagenet: A large-scale hierarchical image database. In Computer Vision and Pattern Recognition, 2009. CVPR 2009. IEEE Conference on, pages 248-255. IEEE, 2009.
[5] Suyog Gupta, Ankur Agrawal, Kailash Gopalakrishnan, and Pritish Narayanan. Deep learning with limited numerical precision. In Proceedings of the 32nd International Conference on Machine Learning (ICML-15), pages 1737-1746, 2015.
[6] Jakub Konečn\grave{y}, H Brendan McMahan, Felix X Yu, Peter Richtárik, Ananda Theertha Suresh, and Dave Bacon. Federated learning: Strategies for improving communication efficiency. arXiv prepint arXiv:1610.05492, 2016.
[7] Yujun Lin, Song Han, Huizi Mao, Yu Wang, and William J Dally. Deep gradient compression: Reducing the communication bandwidth for distributed training. arXiv preprint arXiv:1712.01887, 2017.
[8] H Brendan McMahan, Eider Moore, Daniel Ramage, Seth Hampson, et al. Communication-efficient learning of deep networks from decentralized data. arXiv preprint arXiv:1602.05629, 2016.
[9] Frank Seide, Hao Fu, Jasha Droppo, Gang Li, and Dong Yu. 1-bit stochastic gradient descent and its application to data-parallel distributed training of speech dnns. In Fifteenth Annual Conference of the International Speech Communication Association, 2014.
[10] Reza Shokri and Vitaly Shmatikov. Privacy-preserving deep learning. In Proceedings of the 22nd ACM SIGSAC conference on computer and communications security, pages 1310-1321. ACM, 2015.
[11] Nikko Strom. Scalable distributed dnn training using commodity gpu cloud computing. In Sixteenth Annual Conference of the International Speech Communication Association, 2015
[12] Wei Wen, Cong Xu, Feng Yan, Chunpeng Wu, Yandan Wang, Yiran Chen, and Hai Li. Temgrad: Ternary gradients to reduce communication in distributed deep learning. arXiv preprint arXiv:1705.07878, 2017.
[13] Thomas Wiegand and Heiko Schwarz. Source coding: Part i of fundamentals of source and video coding. Found. Trends Signal Process., 4(1&#8211;2):1-222, January 2011.
[14] Shuchang Zhou, Yuxin Wu, Zekun Ni, Xinyu Zhou, He Wen, and Yuheng Zou. Dorefa-net: Training low bitwidth convolutional neural networks with low bitwidth gradients. arXiv preprint arXiv:1606.06160, 2016.
[15] Jakub Konečn\grave{y}, H Brendan McMahan, Felix X Yu, Peter Richtárik, Ananda Theertha Suresh, and Dave Bacon. Federated learning: Strategies for improving communication efficiency. arXiv preprint arXiv:1610.05492, 2016.
[16] H Brendan McMahan, Eider Moore, Daniel Ramage, Seth Hampson, et al. Communication-efficient learning of deep networks from decentralized data. arXiv preprint arXiv:1602.05629, 2016.

1. A method for federated learning of a neural network by clients in cycles, the method comprising in each cycle
downloading, to a predetermined client, information on a setting of a parameterization of the neural network,
the predetermined client,
updating the setting of the parameterization of the neural network using training data at least partially individually gathered by the respective client to acquire a parameterization update, and
uploading information on the parameterization update,
merging the parameterization update with further parametrization updates of other clients to acquire a merged parameterization update defining a further setting for the parameterization for a subsequent cycle,
wherein the uploading of the information on the parameterization update comprises lossy coding of an accumulated parametrization update corresponding to a first accumulation of the parameterization update of a current cycle on the one hand and coding losses of uploads of information on parameterization updates of previous cycles on the other hand.

2. The method of claim 1,
wherein the downloading the information on the setting of the parameterization of the neural network in the current cycle comprises downloading the merged parametrization update of a preceding cycle by lossy coding of an accumulated merged parametrization update corresponding to a second accumulation of the merged parametrization update of the preceding cycle on the one hand and coding losses of previous downloads of merged parametrization updates of cycles preceding the preceding cycle on the other hand.

3. The method of claim 1,
wherein the clients gather the training data independent from each other.

4. The method of claim 1, wherein the lossy coding comprises
determining a coded set of parameters of the parametrization,
coding, as the information on the parameterization update, identification information which identifies the coded set of parameters, and one or more values as a coded representation of the accumulated parametrization update for the coded set of parameters, wherein the coding loss is equal to
the accumulated parametrization update for parameters outside the coded set or
the accumulated parametrization update for parameters outside the coded set and a difference between the accumulated parametrization update and the coded representation for the coded set of parameters.

5. The method of claim 4, wherein
an average value of the accumulated parametrization update for the coded set of parameters is coded as the one or more values so as to represent all parameters within the coded set of parameters.

6. A system for federated learning of a neural network in cycles, the system comprising a server and clients and configured to, in each cycle
download, from the server to a predetermined client, information on a setting of a parameterization of the neural network,
the predetermined client,
updating the setting of the parameterization of the neural network using training data at least partially individually gathered by the respective client to acquire a parameterization update, and
uploading information on the parameterization update,
merge, by the server, the parameterization update with further parametrization updates of other clients to acquire a merged parameterization update defining a further setting for the parameterization for a subsequent cycle,
wherein the uploading of the information on the parameterization update comprises lossy coding of an accumulated parametrization update corresponding to a first accumulation of the parameterization update of a current cycle on the one hand and coding losses of uploads of information on parameterization updates of previous cycles on the other hand.

7. A client device for decentralized training contribution to federated learning of a neural network in cycles, the client device being configured to, in each cycle,
receive information on a setting of a parameterization of the neural network,
gather training data,
update the setting of the parameterization of the neural network using the training data to acquire a parameterization update, and
uploading information on the parameterization update for being merged with the parameterization updates of other clients devices to acquire a merged parameterization update defining a further setting of the parameterization for a subsequent cycle,
wherein the client device is configured to, in uploading the information on the parameterization update, lossy code an accumulated parametrization update corresponding to a first accumulation of the parameterization update of a current cycle on the one hand and coding losses of uploads of information on parameterization updates of previous cycles on the other hand.

8. The client device of claim 7, configured to, in lossy coding the accumulated parameterization update,
determine a first set of highest update values of the accumulated parametrization update and a second set of lowest update values of the accumulated parametrization update,
select among the first and second sets a—in terms of absolute average—largest set,
code, as information on the accumulated parametrization update,
identification information which identifies a coded set of parameters of the parametrization a corresponding update value of the accumulated parametrization update of which is comprised in the largest set and
an average value of the largest set.

9. The client device of claim 7, configured to
perform the lossy coding the accumulated parameterization update using entropy coding using probability distribution estimates derived from an evaluation of the lossy coding of the accumulated parameterization update in previous cycles.

10. The client device of claim 7, configured to
gather the training data independent from the other client devices.

11. A method for decentralized training contribution to federated learning of a neural network in cycles, the method comprising, in each cycle,
receiving information on a setting of a parameterization of the neural network,
gathering training data,
updating the setting of the parameterization of the neural network using the training data to acquire a parameterization update, and
uploading information on the parameterization update for being merged with the parameterization updates of other clients deices to acquire a merged parameterization update defining a further setting of the parameterization for a subsequent cycle,
wherein the method comprises, in uploading the information on the parameterization update, lossy coding an accumulated parametrization update corresponding to a first accumulation of the parameterization update of a current cycle on the one hand and coding losses of uploads of information on parameterization updates of previous cycles on the other hand.

12. A method for distributed learning of a neural network by clients in cycles, the method comprising, in each cycle
downloading, to a predetermined client, information on a setting of a parameterization of the neural network,
the predetermined client
updating the setting of the parameterization of the neural network using training data to acquire a parameterization update, and
uploading information on the parameterization update,
merging the parameterization update with further parametrization updates of the other clients to acquire a merged parameterization update which defines a further setting of the parameterization for a subsequent cycle,
wherein, in a predetermined cycle, the downloading the information on the setting of the parameterization of the neural network comprises downloading information on the merged parametrization update of a preceding cycle by lossy coding of an accumulated merged parametrization update corresponding to a first accumulation of the merged parametrization update of the preceding cycle on the one hand and coding losses of downloads of information on merged parametrization updates of cycles preceding the preceding cycle on the other hand.

13. The method of claim 12,
wherein the clients gather the training data independent from each other.

14. The method of claim 12, wherein the lossy coding comprises
determining a coded set of parameters of the parametrization,
coding, as the information on the merged parameterization update, identification information which identifies the coded set of parameters, and one or more values as a coded representation of the accumulated merged parametrization update for the coded set of parameters, wherein the coding loss is equal to
the accumulated merged parametrization update for parameters outside the coded set or
the merged accumulated parametrization update for parameters outside the coded set and a difference between the accumulated merged parametrization update and the representation for the coded set of parameters.

15. The method of claim 14, wherein
an average value of the merged accumulated parametrization update for the coded set of parameters is coded as the one or more values so as to represent, at least in terms of magnitude, all parameters within the coded set of parameters.

16. A system for distributed learning of a neural network in cycles, the system comprising a server and clients and configured to, in each cycle
download, from the server to a predetermined client, information on a setting of a parameterization of the neural network,
the predetermined client
updating the setting of the parameterization of the neural network using training data to acquire a parameterization update, and
uploading information on the parameterization update,
merge, by the server, the parameterization update with further parametrization updates of the other clients to acquire a merged parameterization update which defines a further setting of the parameterization for a subsequent cycle,
wherein, in a predetermined cycle, the downloading the information on the setting of the parameterization of the neural network comprises downloading information on the merged parametrization update of a preceding cycle by lossy coding of an accumulated merged parametrization update corresponding to a first accumulation of the merged parametrization update of the preceding cycle on the one hand and coding losses of downloads of information on merged parametrization updates of cycles preceding the preceding cycle on the other hand.

17. An apparatus for coordinating a distributed learning of a neural network by clients in cycles, the apparatus configured to, per cycle,
download, to a predetermined client, information on a setting of a parameterization of the neural network for sake of the clients updating the setting of the parameterization of the neural network using training data to acquire a parameterization update,
receive information on the parameterization update from the predetermined client,
merge the parameterization update with further parametrization updates from other clients to acquire a merged parameterization update which defines a further setting of the parameterization for a subsequent cycle,
wherein the apparatus is configured to, in a predetermined cycle, in downloading the information on the setting of the parameterization of the neural network, download the merged parametrization update of a preceding cycle by lossy coding of an accumulated merged parametrization update corresponding to a first accumulation of the merged parametrization update of the preceding cycle on the one hand and coding losses of downloads of information on merged parametrization updates of cycles preceding the preceding cycle on the other hand.

18. The apparatus of claim 17, configured to, in lossy coding the accumulated merged parameterization update,
determine a first set of highest update values of the accumulated merged parametrization update and a second set of lowest update values of the accumulated merged parametrization update,
select among the first and second sets a—in terms of absolute average—largest set,
code, as information on the accumulated parametrization update,
identification information which identifies a coded set of parameters of the parametrization a corresponding update value of the accumulated merged parametrization update of which is comprised in the largest set and
an average value of the largest set.

19. The apparatus of claim 17, configured to
perform the lossy coding the accumulated merged parameterization update using entropy coding using probability distribution estimates derived from an evaluation of the lossy coding of the accumulated merged parameterization update in previous cycles.

20. A method for coordinating a distributed learning of a neural network by clients in cycles, the method comprising, per cycle,
downloading, to a predetermined client, information on a setting of a parameterization of the neural network for sake of the clients updating the setting of the parameterization of the neural network using training data to acquire a parameterization update,
receiving information on the parameterization update from the predetermined client,
merging the parameterization update with further parametrization updates from other clients to acquire a merged parameterization update which defines a further setting of the parameterization for a subsequent cycle,
wherein the method comprises, in a predetermined cycle, in downloading the information on the setting of the parameterization of the neural network, downloading the merged parametrization update of a preceding cycle by lossy coding of an accumulated merged parametrization update corresponding to a first accumulation of the merged parametrization update of the preceding cycle on the one hand and coding losses of downloads of information on merged parametrization updates of cycles preceding the preceding cycle on the other hand.

21. A non-transitory digital storage medium having stored thereon a computer program for performing a method for federated learning of a neural network by clients in cycles, the method comprising in each cycle
downloading, to a predetermined client, information on a setting of a parameterization of the neural network,
the predetermined client,
updating the setting of the parameterization of the neural network using training data at least partially individually gathered by the respective client to acquire a parameterization update, and
uploading information on the parameterization update,
merging the parameterization update with further parametrization updates of other clients to acquire a merged parameterization update defining a further setting for the parameterization for a subsequent cycle,
wherein the uploading of the information on the parameterization update comprises lossy coding of an accumulated parametrization update corresponding to a first accumulation of the parameterization update of a current cycle on the one hand and coding losses of uploads of information on parameterization updates of previous cycles on the other hand,
when said computer program is run by a computer.

22. A non-transitory digital storage medium having stored thereon a computer program for performing a method for coordinating a distributed learning of a neural network by clients in cycles, the method comprising, per cycle,
downloading, to a predetermined client, information on a setting of a parameterization of the neural network for sake of the clients updating the setting of the parameterization of the neural network using training data to acquire a parameterization update,
receiving information on the parameterization update from the predetermined client,
merging the parameterization update with further parametrization updates from other clients to acquire a merged parameterization update which defines a further setting of the parameterization for a subsequent cycle,
wherein the method comprises, in a predetermined cycle, in downloading the information on the setting of the parameterization of the neural network, downloading the merged parametrization update of a preceding cycle by lossy coding of an accumulated merged parametrization update corresponding to a first accumulation of the merged parametrization update of the preceding cycle on the one hand and coding losses of downloads of information on merged parametrization updates of cycles preceding the preceding cycle on the other hand,
when said computer program is run by a computer.
